(19) United States
(12) Patent Application Publication
(10) Pub. No.: US 2002/0198743 A1
(43) Pub. Date: Dec. 26, 2002

(54) Network architecture and management system for conducting insurance activities on a network

(76) Inventors: Arjuna A. Ariathurai, Chicago, IL (US); Jeffrey M. Heitman, Chicago, IL (US); Christian J. Sinclair, Chicago, IL (US); Stephen J. Sinclair JR., Chicago, IL (US)

Correspondence Address: BELL, BOYD & LLOYD, LLC, PO BOX 1135, CHICAGO, IL, 60690-1135, US

(21) Appl. No.: 09/885,812

(22) Filed: Jun. 20, 2001

(51) Int. Cl. G06F 17/60

(52) U.S. Cl. 705/4

(57) ABSTRACT

The present invention includes a network architecture and system which enables users to electronically conduct insurance transactions over a network, such as the Internet. Preferably, the network architecture is of the client/server/server type which operates with the transfer of standardized data, such as XML files, between server and server and server and client. It is also preferable that the management system is supported by this architecture and enables users to operate and manage insurance-related businesses on the network, including the transactional, accounting and other aspects of such businesses. The network architecture and management system of the present invention provides insurance agents, agent affiliates or producers, insurance carriers or providers and others with increased efficiency, convenience and effectiveness in the performance of insurance industry activities.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### DESCRIPTION

The present invention relates generally to a system for conducting insurance-related activities, and more specifically, to a network architecture and management system which enables an insurance agent to transfer insurance data, in a meaningful form, between servers of different insurance carriers and computers of insurance agents, customers and others in real time over a network, and which also enables insurance agents to manage their businesses by accessing such network and using programs and databases designated for the insurance agents.

### BACKGROUND OF THE INVENTION

### I. Insurance Transactions

### A. Purchasing With Paper-Based Techniques

Independent insurance agents and other agents represent a variety of different insurance carriers. For example, agency A may sell polices issued by insurance carriers X, Y and Z. The customer can choose the most desirable carrier, such as the carrier with the lowest premium or the carrier with the best reputation. In order for an agent to obtain a policy from a carrier for a customer, the agent must exchange insurance information and documents with the carrier.

The current, common practice in the insurance industry is for an insurance agent to exchange paper with its insurance carriers when customers purchase policies. This practice involves mostly faxing and some mailing of paper documents (such as customer applications, quotes, binders and policies) between the insurance agent, affiliates of the agent and the insurance carrier issuing the policy. Conducting insurance transactions in this manner is a relatively lengthy and costly process.

### B. Purchasing On Discrete-Based Networks

Though the vast majority of insurance agencies employ such paper-based techniques for an insurance transaction, a relatively small percentage of insurance agencies and insurance carriers employ a limited form of electronic communication. Here, an insurance agency is connected to an insurance carrier through a discrete-based private network. The discrete-based network restricts communication to a predetermined schedule. Parties can only communicate at set times, as opposed to real-time networks where parties can communicate anytime. For example, if an agent wants to transmit an application to a carrier over a discrete-based network, the agent can only do so in accordance with a predetermined time schedule, for instance, at the beginning of the day or end of the day. For this type of network, a transmission from an agent to a carrier is commonly known as a “file upload,” and a transmission from a carrier to an agent is commonly known as a “file download.”

Because these networks are discrete-based, in order for agents and carriers to send an upload file or a download file outside of the set transmission schedule, they must send the document in paper form through facsimile. Consequently, the disadvantages of the paper technique remain. Also, customers and the general public cannot access these networks. Furthermore, with this type of network, agents can only access their customer and business information stored on their computer systems from a limited number of access terminals.

### C. Quoting On the Internet

Certain insurance agency websites on the Internet enable customers to conduct pre-purchase transactions on-line, such as submitting electronic applications and obtaining electronic quotes. The traditional agency website provides a quote form which enables prospective customers to enter information into a form and e-mail the form to an agent. An agent uses the information to e-mail a quote back to the prospective customer. In preparing the quote, the agent uses the quote rules of the insurance carrier selected by the customer. If the customer wants to purchase a policy, the agent must use the paper techniques to send an application to the carrier, obtain a binder, send the binder and bill to the customer and send the policy to the customer.

Some agency websites now enable prospective customers to obtain on-line policy quotes by predetermined insurance carriers in real-time. The web servers of these agency websites provide the quotes by retrieving quote data stored in a quote database. For example, the quote database may includes quote data associated with insurance carrier A, carrier B and carrier C. If a prospective customer requests quotes for insurance by carrier A and carrier C, the web server uses the quote data associated with such insurance carriers to generate quotes.

With this client/server architecture used by the traditional and contemporary agency websites, the web servers do not communicate with third party insurance carrier servers in order to generate quotes. Consequently, the quote data is static and not instantly up-to-date with changes made by insurance carriers. Also, customers can only obtain quotes for insurance by a limited number of insurance carriers—the carriers whose quote data is stored in the quote database. In addition, the quote data of certain carriers may not readily be stored in the quote database because the quote data format may be incompatible with the format of the quote data already in the database. Moreover, these agency websites only allow for quotes. No known agency websites enable customers to complete an entire insurance transaction on-line, from the quote to the purchase.

### D. Purchasing On the Internet

Although no known agency websites enable customers to purchase policies from carriers on-line, certain websites of insurance carriers allow for such purchasing. Specifically, some insurance carrier websites are known which enable customers to obtain the carrier's quotes and to purchase the carrier's insurance policies on-line with a credit card. With this client/server architecture, the carrier's web server communicates with the carrier's database. Because these websites are websites of carriers, by design they do not enable customers to choose one of various policies by different carriers and to then purchase that desired policy.

### II. Management of Insurance Information

Insurance agents or agencies generally manage information related to customers and the customers' insurance using several unrelated software programs and paper files. Typically, agencies maintain information relating to insured customers in paper-based files. This information includes the policy application and the issued policy and notes created by agents during the sales and binding process. Other information, such as customer information, billing information and accounting information generally is managed using disparate software packages which do not readily integrate. Because information about customers is kept in several places, retrieving information related to a specific customer is often a relatively complicated, time consuming process. The complicated process of retrieving information in the management of customer relations results in a relatively high cost incurred by agencies. Additionally, most insurance agencies use discrete accounting software packages which requires agencies to track and reconcile insurance-related accounting information by exchanging paper with affiliates through facsimile.

Furthermore, since insurance agents typically represent several different insurance carriers, the particularities of the different insurance carriers creates an administrative burden for insurance agents. For example, insurance carrier A's binder form may differ substantially from insurance carrier B's binder form. Consequently, agents must manually retrieve certain data from a binder, such as the expiration date, in order to docket this data in agency software.

The costs associated with purchasing and maintaining computer systems which manage insurance transaction information are relatively high for the typical insurance agency or brokerage. Costs include purchasing and maintaining computer systems to store information and applications, purchasing new computer software and upgrades, as well as technical support costs related to the repair and maintenance of computer systems and software. The installation of computer software also creates costs due to the disruption of business. In addition, this office-based technique of managing insurance information hinders agents in their ability to service customers when the agents are outside of their offices.

There is currently no known network architecture and management system which: (a) enables agents to electronically conduct entire insurance transactions (including the sale of policies) with a plurality of different insurance carriers in real-time; (b) enables agents to efficiently and conveniently access, track and manage insurance transactions and information; and (c) enables agents to perform all of the foregoing activities anywhere by connecting an electronic device (such as a desktop or laptop computer) to a network, such as the Internet.

### SUMMARY OF THE INVENTION

The present invention overcomes the above shortcomings by providing a network architecture and management system which enables insurance agents to enter, track and process back-office operations in an effort to insure, cancel or re-insure customers. The network architecture of one embodiment of the present invention is a combination of client/server and server/server architecture which supports the exchange of insurance-related standardized data. The management system, preferably supported by this network architecture, enables agents to operate and manage their agency business on-line in real time, preferably through a website designated for the agents.

The term “agent,” as used herein, includes a producer, broker or agent of any type, such as an independent, captive or managing general agent. The term “affiliate,” as used herein, includes a business or transactional partner of an agent, a party which refers customers to an agent or any other party having a business relationship with an agent. The term “carrier,” as used herein, includes an underwriter, insurance provider or reinsurer, policy issuance vendor, a company which issues insurance policies or any other company which carries or provides insurance to other parties. The term “customer,” as used herein, includes an actual, potential or prospective insured party or purchaser of insurance, financial or other products or services provided by an agent, affiliate or carrier.

In one embodiment of the present invention, the network architecture includes: (a) one or more computers connected to an implementor server through a network, preferably a wide-area network; and (b) at least one insurance carrier server connected to the implementor server through the network. Preferably, at least one resource provider server or resource server is also connected to the implementor server through the network. A resource provider can include any party, source or server which provides resources or information to other parties, including, without limitation, forms providers and rating engines. It should be appreciated that an insurance carrier server can include a server owned, directly controlled or directly operated by an insurance carrier or any server controlled or operated for the benefit of the insurance carrier by a third party. Similarly, an insurance resource server can include a server owned, directly controlled or directly operated by an insurance resource provider or any server controlled or operated for the benefit of the insurance resource provider by a third party.

The computers preferably include a processor, one or more input/output devices and a modem or other suitable device enabling the computers to electronically connect to the network. It should be appreciated, however, that the term “computer,” as used herein includes any network access device or electronic device which has the capacity to electronically connect to a network. The network includes any electronic channel which enables processors to electronically communicate with one another through telephone lines, cable lines, digital lines, optical fiber, radio waves, satellite transmission or any other suitable communication channel.

The term “server,” as used herein, includes a processor which operates on or is electronically connected to a network. In one embodiment, the server is an application server which can process data in response to requests from a plurality of different client computers, regardless of the client computers' type of platform or the programs used by the client computer, as long as the client computers use a suitable browser program. The implementor server uses an implementor storage device or database and implementor programs to process, generate and store data and to perform other activities. Similarly, the carrier server and resource server each use storage devices or databases and programs to process, generate and store data. A storage device or data storage device includes any memory device or other device having the capacity to store computer programs, instructions or data.

The network architecture of the present invention enables an agent, an affiliate of an agent, a customer or an insurance carrier to send information to and receive information from the implementor server. In one embodiment, the implementor programs include standardized data generator code. The standardized data generator code includes any suitable set of computer instructions which enables the implementor server to receive an electronic request (from an agent computer for example) and to standardize the data included in that request by generating standardized data which can be processed by a plurality of different processors or servers using different platform types or language types.

The term “standardized data,” as used herein, includes data which can be processed by different processors which operate on different types of hardware or software. Preferably, the standardized data is fully hardware and software independent. Standardized data can include proprietary data and/or publicly available industry data. Non-standardized data is dependent upon a predetermined type of hardware and/or software.

Preferably, the computers, carrier server and resource server each use programs which enable them to process the standardized data. Alternatively, the carrier server and the resource server can have separate standardized data generator code within their programs or standardized data pre-stored in their databases.

In any case, using the standardized data, the implementor server can receive a non-standardized data request (from an agent computer for example) and in response transmit a standardized data request to a carrier server and/or resource server. The carrier server and/or resource server then provide a standardized data response to the implementor server. The implementor server can then read the standardized data response and transmit it to one or more of the computers. The computers can then process the standardized data and generate displays and other outputs for users. The term “user” is used herein from time to time to includes a person who is operating a computer or other device which is electronically connected to the network.

An insurance agent, affiliate, customer or carrier may access a network through text-based program, graphical-based interface program, a suitable terminal program or any other type of suitable program used by the computer. In one example, an agent may transmit a request for a policy quote to the implementor server. The implementor server stores the raw data for the request in the implementor database. Preferably, the request includes information regarding a prospective insured or customer. As instructed by the implementor programs, the implementor server generates standardized data based upon the request and preferably stores a copy of this standardized data in the implementor database. The implementor server then transmits this standardized data to the carrier server.

The insurance carrier server then either automatically transmits a standardized data quote to the implementor server or prompts an administrator to do so. The implementor server will then store that standardized data quote in the implementor database and transmit the quote to the agent computer. The agent using the computer can then read, download, print or electronically forward the quote to a customer.

In addition, at anytime the agent can request certain insurance information or resources which are relevant to the quote or otherwise helpful to the agent, the agent's business or a customer. Insurance resources can include forms, spreadsheets, charts, graphs, tables, formulas, methodologies, treatises, books, articles, manuals, journals, rules, laws or any other information applicable or related to the insurance industry. To request an insurance resource, the agent can send a request to the implementor server for a particular resource, such as a chart which helps a customer select a policy which is most appropriate for the customer's specific needs. The implementor server will process this request and transmit a standardized data request to a resource server.

The resource server will then return a standardized data response to the implementor server, which will in turn, transmit the standardized data response to the agent computer and/or customer computer. The agent or customer can then read, print and use the insurance resource.

In one embodiment, the network architecture includes: (a) a plurality of computers connected to the Internet; (b) a web server connected to the Internet and functioning as a host for a website; (c) an implementor server connected to the web server through the Internet; and (d) at least one carrier server connected to the implementor server through the Internet. Preferably, the network architecture also includes at least one resource server connected to the implementor server through the Internet. The general architecture of this network architecture includes a combination of client/server architecture and server/server architecture.

The computers include the hardware and software necessary for these computers to electronically connect to the Internet. Preferably, the computers each include an Internet browser program which enables the computers to process data received through the Internet and to output this data in the form of graphics and sound. The term “Internet,” as used herein, includes any portion of the Internet such as the World Wide Web or the high-speed portion of the Internet under development commonly known as Internet2, any intranet which provides access to the Internet or any suitable link or linkage which provides access to the Internet.

The web server uses programs, Hypertext Markup Language (HTML) files and a storage device or database to host the website. The storage device or database includes raw data related to insurance. The computers' browsers use the HTML files to present the raw data to users on a web page in a particular format. The website is preferably designated for a particular insurance agency or agent. The web server provides responses to agents and others who make requests at the agent website.

In one embodiment, the carrier server and the resource server do not have the hardware or software configuration necessary to process data which is included within HTML files. Therefore, an HTML request from a computer would be meaningless to the carrier server and the resource server. The use of a publicly available, standardized data format known as Extensible Markup Language (XML) enables the meaningful exchange of data between: (a) the computers hosted by the web server; and (b) the carrier server or the resource server. An XML file is data, specifically a plain text file which includes data in a standardized format. XML standardizes data by specifying, categorizing or classifying various types of information through the use of tags, attributes and other classifiers and factors.

The implementor programs preferably include network code, database request code, server request code and management code. The network code includes standardized data generator code which is preferably XML file generator code. The network code also includes standardized data processor code which is preferably XML file parser code. The computers, the web server, the carrier server and the resource server use suitable programs or data which enable them to process the XML files and the data included in the XML files. In one embodiment, a single server provides the functionality of both the web server and the implementor server required by the network architecture of the present invention.

In operation of the implementor server in one embodiment of the present invention, when the implementor server receives an XML request, the implementor server initially parses the XML request. By parsing the XML request, the implementor server retrieves the data contained within the XML request. Next, the implementor server determines if the request is valid or invalid. If the request is invalid, the implementor server determines the error and then generates an XML error response. When the implementor server determines that the request is valid, the implementor server proceeds to determine what type of request has been made.

If the request is a database request, the implementor server uses database request code to generate an appropriate database request. The implementor server then executes this database request, using specific data in the database. When executing the request, the implementor server uses XML file generator code to generate specific XML files. The implementor server generates an XML response with the XML files.

If the request was a request from a peer server such as carrier server or resource server, the implementor server uses server request code to generate a request and send a request to a peer server. The peer server then processes the request and returns an XML response to the implementor server. The peer server can generate an XML response by using its programs to generate the XML response or by using pre-existing XML files. The implementor server then processes the peer server's XML response and generates its own XML response.

If the request is a management request, the implementor server uses the management code to execute one or more predetermined functions on the data extracted from the XML request. These predetermined functions can involve mathematical formulas, calculations and other data manipulations. The implementor server then generates output data after performing these functions. The implementor server then generates an XML response which includes this output data. Finally, the implementor server provides its XML response to the requesting server or user.

This network architecture of the present invention enables agents, affiliates, customers and carriers to seamlessly transfer information to and from one another regarding insurance transactions. The agents compile a database of information by using graphical interfaces. The information or data includes information related to quotes on insurance, insurance policies which are issued or canceled, invoice information related to billing customers and accounting information related to the insurance transactions. Multiple users at one insurance agency, brokerage or carrier can access, insert or update information into the implementor database through a client browser interface. Users can access data through the presentation of queried data on client web pages and printable reports which are rendered within a client browser. Agents can access data relating to customers, policies, invoices, quotes or accounting related functions. Agents can insert or update the data using browser interfaces which are specific to the type of information being entered. For example, a customer editor could be used to enter or update information related to a specific customer.

In addition, agents or insurance professionals can keep journals and assign tasks related to the management of customers, policies, invoices or accounting. These journals are managed using the implementor server. When dealing with a customer or business partner, the agent or insurance professional can access transactional information related to a specific request through the browser, and the agent can view notes, journals or activities related to the specific business partner or customer.

In one embodiment, all of the transactions involve creating and sending an XML request and then receiving an XML response which the implementor server parses and then loads into the computer's browser or interface. The servers are all located off the agent's or agency's premises and are managed by the implementor of the present invention.

In one example, a prospective customer visits an agent's or an agency's website, completes a policy application available at that website and then transmits that application to the web server which is hosting the agency website. An agent then, accessing his/her agency's website, would receive the completed application. The agent may personally calculate quotes, or the agent may transmit the application to carriers or other parties in order to obtain electronic quotes. Upon receiving the electronic quotes for insurance by different carriers, the agent can forward or transmit these quotes to the prospective customer.

The prospective customer can then compare the quotes from the different carriers. If the prospective customer decides to purchase a policy offered by a desired carrier, the agent can transmit a binder to the prospective customer. The customer can electronically sign the binder through the use of suitable encryption technology, or the customer can physically print and sign the document, scan the signature page of the document and transmit the scanned image to the agent. The agent can then electronically transmit the binder to a carrier, or the agent can electronically transmit notice of the executed binder to the carrier. The agent or the carrier can then transmit a bill or invoice to the customer for payment. The carrier can then electronically transmit the actual policy to the agent, or the carrier can fax, mail or otherwise send a copy of the policy to the agent.

The management system or system of the present invention, which is preferably supported by the network architecture, enables agents, agencies, affiliates and others to conveniently, efficiently and effectively manage and operate their insurance business. The system includes: (a) a server (preferably the implementor server) operating on a network, preferably the Internet; (b) at least one database (preferably the implementor database) connected to the server; and (c) management code which is suitable for instructing the server to store, organize, manipulate, calculate, generate, transmit and track the flow of certain insurance-related data to predetermined servers or computers.

The management code, program or application includes a plurality of electronic management tools. These tools enable agents or users to relationally store data in a relational implementor database. The implementor database includes a set of related database tables which store information related to all aspects of the insurance underwriting process, including customer information, policy information, invoice and billing information and accounting information. The agent or user can access forms of data from this database from any computer which has Internet access and a web browser.

The implementor database enables the implementor server to perform complex analysis on related tables to provide users with comprehensive data management. Thus, users can view data about customers and specific data related to their customer accounts including the policies they currently hold, any old or canceled policies, declined or pending quoted insurance policies and the billing status of the customer. The implementor database also enables users to: (a) track commissions on sold policies, receivables and payables related to specific insurance transactions or aggregated over a period of time; and (b) manage cash payments and receipts on insurance transactions.

In operation of one embodiment of the management system, an agent or other user must first open an account with the implementor of the management system. The implementor then provides the user with a user name and password necessary to use the system. To use the system, the user must log onto the Internet and link to the user's website, a website specifically designated for the user and hosted by the implementor server. By entering the user's user name and password, the user can access a home page and a plurality of other web pages. The user can manage and operate his/her insurance transactions and business by performing various functions presented on these web pages.

The network architecture and management system of the present invention, in one embodiment, is an Internet-based architecture which enables insurance agents to seamlessly perform insurance-related transactions which involve a plurality of third party insurance carriers, customers and third party resource providers. Furthermore, the present invention enables agents to electronically track these transactions and generally manage and operate their agency businesses at an agent website. The network architecture operates with the interchange of standardized data (preferably XML files) which meaningfully flow between servers and computers of any platform or type. The network architecture and management system of the present invention provides increased customer service value, cost savings and convenience to insurance agents and other users.

It is therefore an advantage of the present invention to provide a network architecture and management system for conducting insurance activities such as the sale of insurance policies on a network.

Another advantage of the present invention is to provide a reliable network architecture which supports and facilitates the interchange of standardized data, preferably XML files, between a plurality of servers.

Yet another advantage of the present invention is to provide a management system which enables agents to manage and operate their business on a network, preferably the Internet.

Another advantage of the present invention is to provide a management system which enables agents to manage and operate their business in real time.

Yet another advantage of the present invention is to provide agents with a management system which enables agents to transmit in real time, policy-related information and accounting-related information.

Still another advantage of the present invention is to reduce office, equipment, technology and overhead costs incurred by insurance agents, agencies and insurance carriers.

Another advantage of the present invention is to minimize the disruption of business operations experienced by agents and agencies.

Yet another advantage of the present invention is to eliminate or reduce an agent's or agency's need for installing updates or upgrades to computer systems and software.

Still another advantage of the present invention is to reduce an agent's or agency's software installation requirements.

Another advantage of the present invention is to reduce the costs incurred by agents and agencies associated with the purchase or lease of computer hardware.

Yet another advantage of the present invention is to provide agents and agencies with a system and method for organizing, collating and managing prospective customers for marketing efforts.

Still another advantage of the present invention is to provide agents and agencies with a system and method for tracking and managing the insurance underwriting process.

Another advantage of the present invention is to enable agents and agencies to accurately account for transactions related to the underwriting process as well as transactions related to the general operations of the agent's or agencies' business.

Yet another advantage of the present invention is to enable agents and agencies to track activities and journals related to contacts.

Still another advantage of the present invention is to enable the customers of agents and agencies to access pertinent account information through a network, preferably the Internet.

Other objects, features and advantages of the invention will be apparent from the following detailed disclosure, taken in conjunction with the accompanying sheets of drawings, wherein like numerals refer to like parts, elements, components, steps and processes.

### BRIEF DESCRIPTION OF THE DRAWINGS

FIG. 1 is a schematic diagram of the network architecture of one embodiment of the present invention;

FIG. 2 is a schematic diagram of the network architecture type in one embodiment of the present invention;

FIG. 3 is a schematic diagram of the network architecture in another embodiment of the present invention;

FIG. 4 is a schematic diagram of the network architecture type in another embodiment of the present invention;

FIG. 5 is a schematic diagram of the implementor programs in one embodiment of the present invention;

FIG. 6 is a schematic diagram of the network code in one embodiment of the present invention;

FIG. 7 is a flow diagram of the processing of the implementor server in one embodiment of the present invention;

FIG. 8 is a flow diagram of client to server processing in one embodiment of the present invention;

FIG. 9 is a flow diagram of client to client processing in one embodiment of the present invention;

FIG. 10A is a schematic diagram of the network architecture in another embodiment of the present invention;

FIG. 10B is a schematic diagram illustrating the Application Service Provider (ASP) functionality of the network architecture in one embodiment of the present invention;

FIG. 11 is a schematic diagram of the network architecture in yet another embodiment of the present invention;

FIG. 12 is a table of example electronic insurance transaction documents in one embodiment of the present invention;

FIG. 13 is a flow diagram illustrating a series of electronic insurance transactions resulting in the purchase of an insurance policy in one embodiment of the present invention;

FIG. 14 is a table of example system management tools in one embodiment of the present invention; and

FIGS. 15 through 35 are example screen shots of a user's website in one embodiment of the present invention.

### DETAILED DESCRIPTION OF THE INVENTION

The present invention includes a network architecture for performing insurance activities and a management system which is preferably supported by the network architecture. The present invention enables insurance agents, their affiliates and others to electronically conduct transactions with insurance carriers over a network, such as the Internet. In addition, the present invention provides agents and agencies with a management system, accessible on the network, for managing customer insurance information and the overall agency business.

### I. Network Architecture

### A. Structure and Functionality

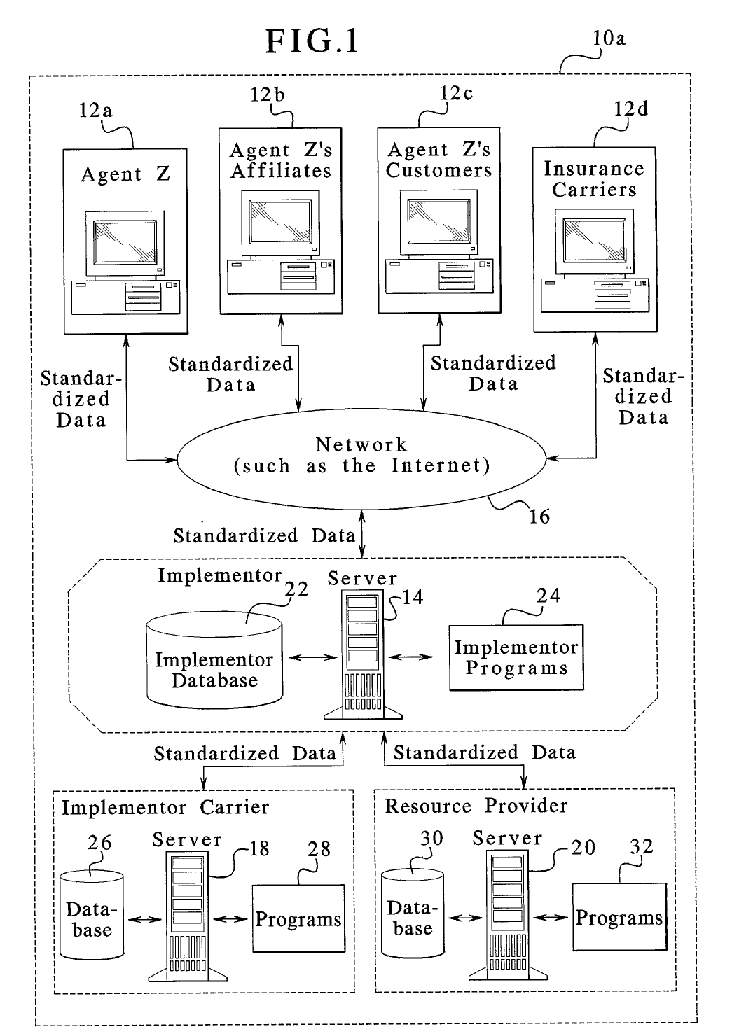

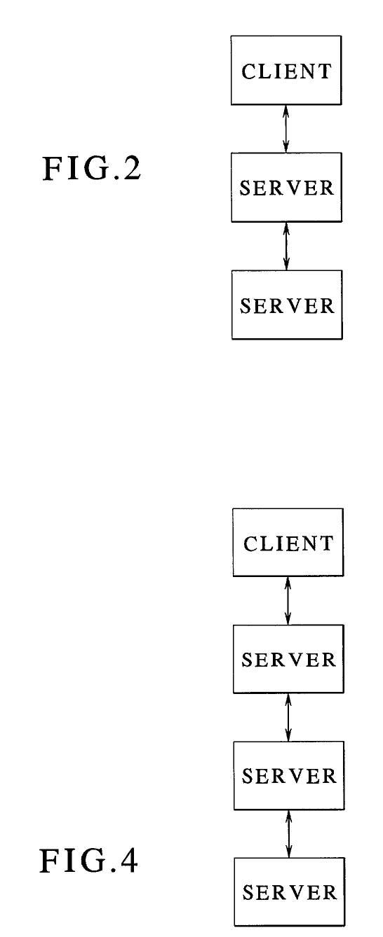

Referring to FIGS. 1 and 2, one embodiment of the network architecture 10a of the present invention includes: (a) one or more computers 12a, 12b, 12c and 12d connected to implementor server 14 through a network 16; and (b) at least one insurance carrier server 18 connected to implementor server 14 through the network 16. Preferably, at least one resource provider server or resource server 20 is also connected to implementor server 14 through the network 16. As illustrated in FIG. 2, the general architecture of network architecture 10a is a combination of client/server architecture and peer-to-peer architecture or client/server/server architecture. Peer-to-peer architecture is referred to herein, at times, as server/server architecture.

The computers 12a through 12d preferably include a processor (not shown), one or more input/output devices and a modem or other suitable device enabling the computers 12a through 12d to electronically connect to network 16. Though network architecture 10a preferably includes resource server 20, it should be appreciated that network architecture 10a need not include resource server 20. In one embodiment described below, the network is the Internet.

Implementor server 14 uses implementor database 22 and implementor programs 24 to process, generate and store data and to perform other activities, as described below. Similarly, carrier server 18 uses database 26 and programs 28 to process, generate and store data, and resource server 20 uses database 30 and programs 32 to process, generate and store data.

As illustrated in FIG. 1, an agent, an affiliate of an agent, a customer or an insurance carrier can send and receive information to and from implementor server 14. In one embodiment, the implementor programs 24 used by implementor server 14 include standardized data generator code.

In another embodiment, the implementor programs 24 do not include the standardized data generator code. Instead, the implementor or other party can store predetermined standardized data in implementor database 22 at the outset. The implementor and others can edit or update this standardized data from time to time. During processing, implementor server 14 can retrieve and use the standardized data stored in implementor database 22.

Preferably, computers 12a through 12d, carrier server 18 and resource server 20 each use programs which enable them to process the standardized data. Alternatively, carrier server 18 and resource server 20 can have separate standardized data generator code within their programs or standardized data pre-stored in their databases. In any case, using the standardized data, implementor server 14 can receive a non-standardized data request (from an agent computer 12a for example) and in response transmit a standardized data request to a carrier server 18 and/or resource server 20. Carrier server 18 and/or resource server 20 will provide a standardized data response to implementor server 14. Implementor server 14 can then read the standardized data response and transmit it to one or more computers 12a through 12d. Computers 12a through 12d can then process the standardized data and generate displays and other outputs for users.

Preferably, whenever the implementor server 14 receives requests and sends responses, the implementor server 14 stores backup request and response data within implementor database 22. This data stored in implementor database 22 preferably includes data exchanged between an agent and a carrier such as a policy application and a quote. The data stored in implementor database 22 also preferably includes entries made by agents and others when using the management system, described below.

An insurance agent, affiliate, customer or carrier may access a computer 12a, 12b, 12c or 12d through a text-based or graphical-based interface program used by the computer. In one example, an agent may transmit a request for a policy quote to implementor server 14. Preferably, the request includes information regarding a prospective insured or customer. As instructed by the implementor programs 24, implementor server 14 generates multi-carrier or cross-carrier standardized data based upon the request and stores a copy of this standardized data in implementor database 22. Implementor server 14 then transmits this standardized data to carrier server 18.

The insurance carrier server 18 then automatically transmits a standardized data quote to implementor server 14. Alternatively, carrier server 18 can prompt an administrator to review the prospective customer's information, prepare a quote, and to then electronically transmit that quote by using the carrier server 18. In any case, the standardized data quote will be electronically transmitted to implementor server 14. Implementor server 14 will then, as instructed by implementor programs 24, store that standardized data quote in implementor database 22 and transmit the quote to the agent computer 12a.

The agent using computer 12a can then read, download, print or electronically forward the quote to a customer. Alternatively, the agent could have requested implementor server 14 to simultaneously transmit the quote both to agent computer 12a and to a particular customer's computer 12c.

In addition, before or after requesting the quote, the agent can request certain insurance information or resources which are relevant to the quote or otherwise helpful to the agent or customer. To request an insurance resource, the agent can send a request to implementor server 14 for a particular resource, such as a chart which helps a customer select a policy which is most appropriate for the customer's specific needs. Implementor server 14, as instructed by implementor programs 24, will process this request and transmit a standardized data request to a resource server 20.

The resource server 20 can be pre-selected through a contractual relationship with the implementor of the present invention. Alternatively, implementor programs 24 can include suitable programs which enable implementor server 14 to search for a particular insurance resource by sending the request to a plurality of servers or all of the insurance-related servers operating on the network 16. In any case, resource server 20 will then return a standardized data response to implementor server 14, which will, in turn, transmit the standardized data response to the agent computer 12a and/or customer computer 12c. The agent or customer can then read, print and use the insurance resource.

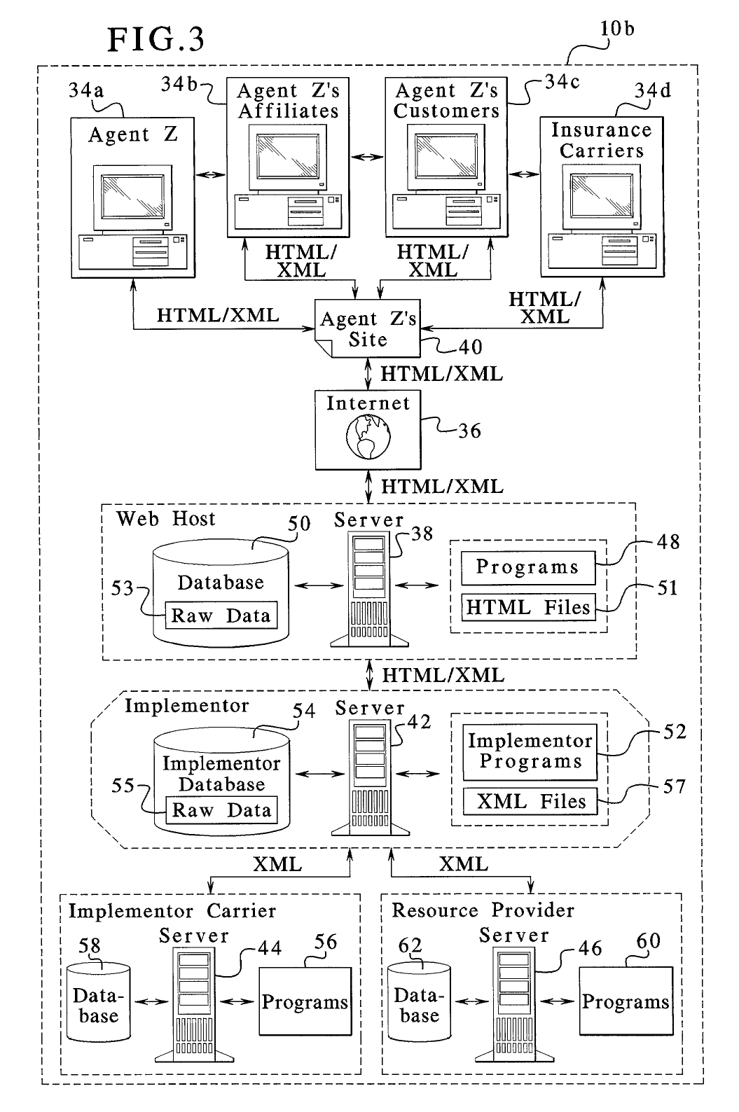

In one embodiment illustrated in FIGS. 3 and 4, network architecture 10b includes: (a) a plurality of computers 34a, 34b, 34c and 34d connected to the Internet 36; (b) a web server 38 connected to the Internet 36 and functioning as a host for website 40; (c) an implementor server 42 connected to web server 38 through the Internet 36; and (d) at least one carrier server 44 connected to implementor server 42 through the Internet 36. Preferably, network architecture 10b also includes at least one resource server 46 connected to implementor server 42 through the Internet 36. As illustrated in FIG. 4, the general architecture of network architecture 10b includes a combination of client/server architecture and server/server architecture.

Computers 34a through 34d include the hardware and software necessary for these computers to electronically connect to the Internet 36. Preferably, computers 34a through 34d each include an Internet browser program which enables the computers to process data received through the Internet and to output this data in the form of graphics and sound. The preferred browser, which is commercially available, is known as Microsoft Internet Explorer, version 5.01 or higher. The computers can use other browsers, when commercially available, such as the version of the browser known as Netscape which is currently under development.

It should be appreciated that although FIG. 3 illustrates desktop computers accessing the Internet 36, a user can access the Internet 36 using any type of computer and any type of electronic device, including, without limitation, laptop or notebook computers, hand-held electronic devices, electronic telephones, on-board devices and any other portable device which has the capacity to electronically connect to the Internet 36, through a hard-wired or wireless connection.

Web server 38 uses programs 48, database 50 and Hypertext Markup Language (HTML) files 51 to host website 40. Database 50 includes insurance-related raw data 53. The computers' browsers use the HTML files to present the raw data to users on a webpage in a particular format. In the example illustrated in FIG. 3, website 40 is a website designated for a particular insurance agency or agent. Web server 38 provides responses to agents and others who make requests at the agent website 40. For example, an agent may click on a hyperlink on the agent website 40, requesting a list of insurance policies which the agent has sold to customers. Web server 38 will use programs 48 to retrieve this particular policy data 53 from database 50 and HTML files 51 to put this data in an HTML format. Web server 38 would then transmit the HTML files to the agent website 40 for viewing by the agent.

Implementor server 42 uses implementor programs 52 to process data, dynamically generate Extensible Markup Language (XML) files 57, generate data, store raw data 55 in implementor database 54 and to transmit XML files 57 in response to requests from web server 38, carrier server 44 or resource server 46. Similarly, carrier server 44 uses programs 56 and database 58 to process data, and resource server 46 uses programs 60 and database 62 to process data.

In one embodiment, the carrier server 44 and resource server 46 do not have the hardware or software configuration or type necessary to process HTML files. Therefore, an HTML request from a computer 34a, 34b, 34c or 34d would be meaningless to the carrier server 44 and resource server 46. The use of XML enables the meaningful exchange of data between: (a) computers 34a through 34d, hosted by web server 38; and (b) carrier server 44 or resource server 46. Preferably, XML files are written for specific industries, such as the pharmaceutical industry, financial industry or insurance industry. It should be appreciated that XML files specific to the insurance industry can be created by a programmer of ordinary skill in the art. Various industry standards and resources are commercially and publicly available to aid one in the programming of XML files for the insurance industry.

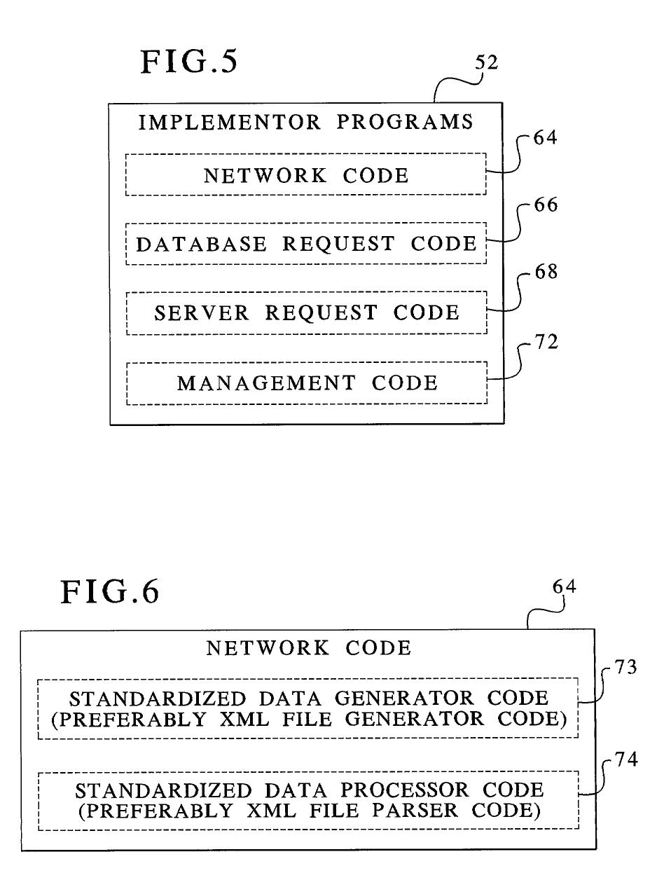

As illustrated in FIG. 5, implementor programs 52 preferably include network code 64, database request code 66, server request code 68 and management code 72. As illustrated in FIG. 6, network code 64 includes standardized data generator code 73. Preferably, the standardized data generator code is XML file generator code, such as an editor program or other suitable program which implementor server 42 can use to dynamically generate XML files 57. Network code 64 also includes standardized data processor code 74. Standardized data processor code 74 can include any suitable code which instructs the implementor server 42 to process standardized data files. Preferably, standardized data processor code 74 is XML file parser code which instructs the implementor server 42 to parse out or retrieve the data included within the XML files.

Computers 34a through 34d, web server 38, carrier server 44 and resource server 46 use suitable programs which enable them to process XML files. Preferably, the browser program used by the computers 34a through 34d and the programs used by web server 38 include instructions which enable the computers and web server to process both XML files and HTML files. In this case, as indicated in FIG. 3 with “HTML/XML,” the computers can display the data in XML files to users in a format determined by HTML files.

In one embodiment, one or more existing programs used by carrier server 44 and resource server 46 are modified so that these servers can process and generate XML files. In another embodiment, programs 56 and 60 used by these servers include a converter program which instructs these servers to process XML files even though the servers, by default, process non-standardized data. In yet another embodiment, an insurance carrier or resource provider or other party can pre-store XML files within the databases 58 and 62 of the carrier server 44 and resource server 46. Here, carrier server 44 and resource server 46 can retrieve the XML files to provide XML responses to implementor server 42.

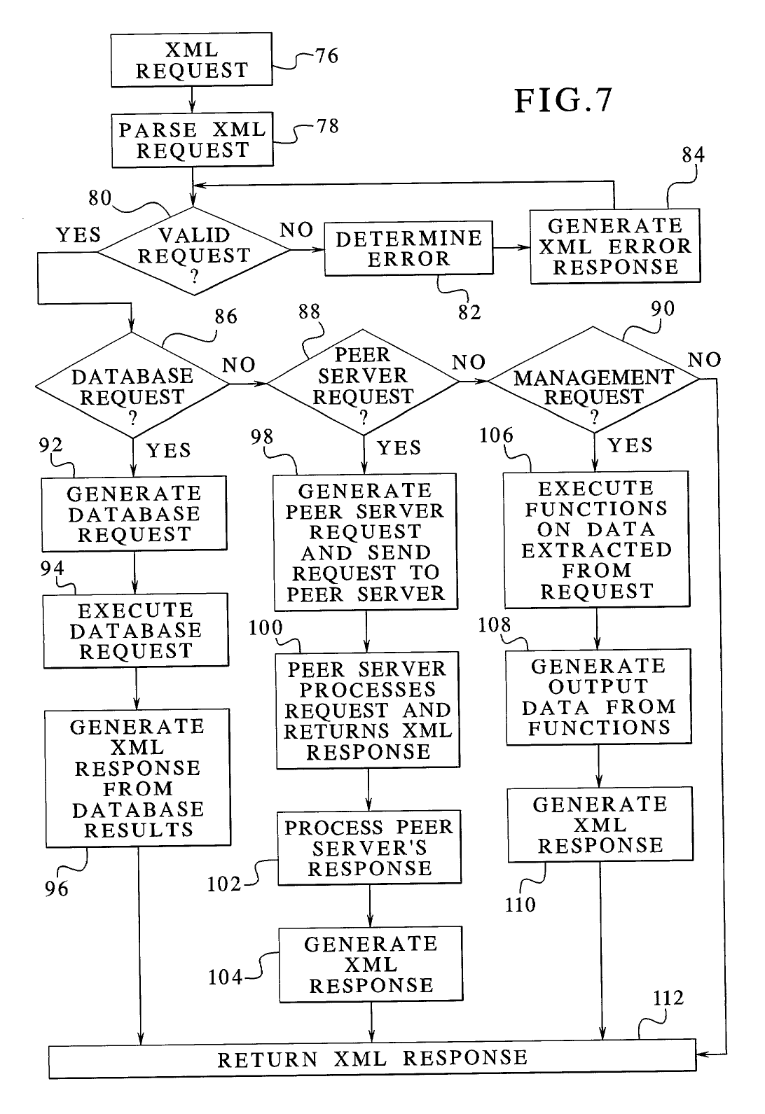

FIG. 7 illustrates the operation of implementor server 42 in one embodiment of the present invention. When implementor server 42 receives an XML request, implementor server 42 initially parses the XML request, as indicated by blocks 76 and 78. By parsing the XML request, implementor server 42 retrieves the data contained within the XML request. Next, implementor server 42 determines if the request is valid or invalid as indicated by diamond 80. If the request is invalid, the implementor server 42 determines the error and then generates an XML error response as indicated by blocks 82 and 84. When implementor server 42 determines that the request is valid, implementor server 42 proceeds to determine what type of request has been made as indicated by diamonds 86, 88 and 90.

If the request is a database request, as indicated by diamond 86, implementor server 42 uses database request code 66 to generate an appropriate database request, as indicated by block 92. Implementor server 42 then executes this database request as indicated by block 94. When executing the request, implementor server 42 retrieves certain data from the database and generates specific XML files. Alternatively, implementor server 42 can simply retrieve certain XML files which are already stored in implementor database 54. In any case, implementor server 42 generates an XML response with the XML files, as indicated by block 96.

If the request was a request from a peer server such as carrier server 44 or resource server 46 as indicated by diamond 88, implementor server 42 uses server request code 68 to generate a request and send a request to a peer server, as indicated by block 98. The peer server then processes the request and returns an XML response to implementor server 42, as indicated by block 100. The peer server can generate an XML response by using its programs to generate the XML response or by retrieving pre-existing XML files stored within its database. As indicated by blocks 102 and 104, implementor server 42 then processes the peer server's XML response and generates its own XML response.

If the request is a management request, as indicated by diamond 90, implementor server 42 uses the management code to execute one or more predetermined functions on the data extracted from the request and/or the raw data stored in the database, as indicated by block 106. These predetermined functions can involve mathematical formulas, calculations and other data manipulations. As indicated by block 108, implementor server 42 then generates output data after performing these functions, as indicated by block 108. Implementor server 42 then generates an XML response which includes this output data as indicated by block 110. Finally, as indicated by block 112, implementor server 42 provides its XML response to the requesting server or user. If the requestor was a user, the implementor server 42 provides an HTML/XML response to the user's browser.

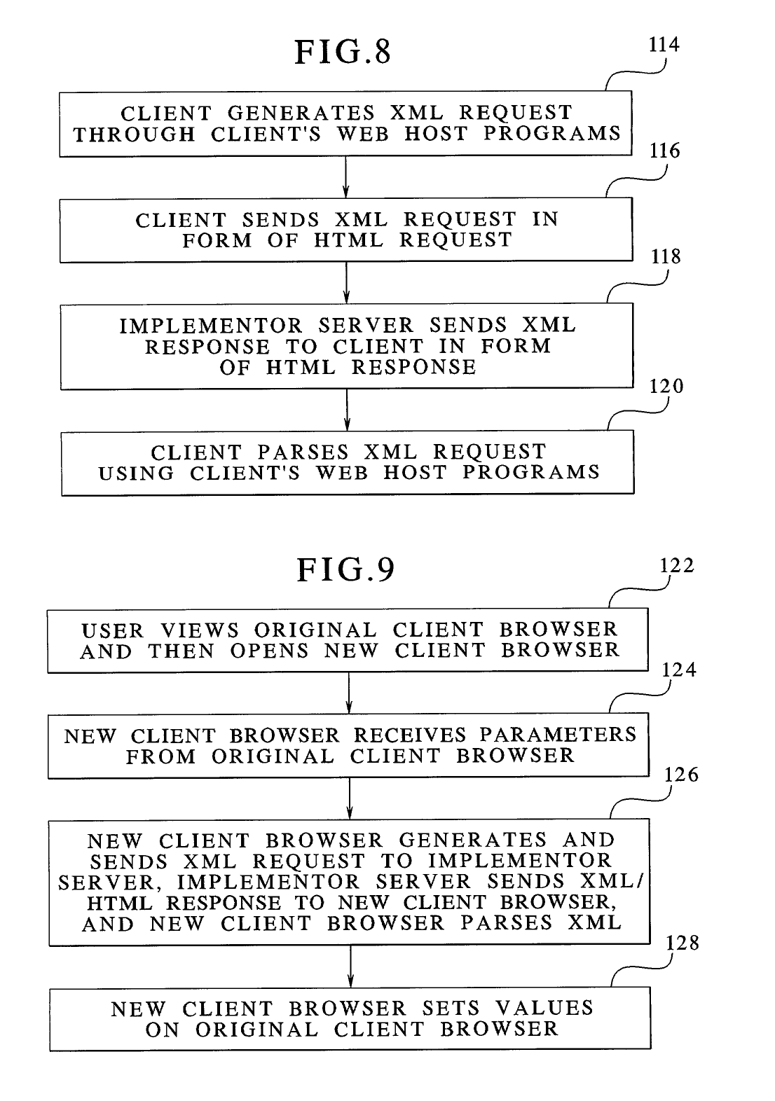

In one embodiment, FIG. 8 illustrates the interaction between: (a) a client computer 34a, 34b, 34c or 34d whose browser is presenting a website 40 hosted by a web server 38; and (b) the implementor server 42. As indicated by block 114, the client generates an XML request through the client's web host programs. The client then sends this XML request in the form of an HTML request to the implementor server 42, as indicated by block 116. The implementor server 42 sends an XML response to the client in the form of an HTML response, as indicated by block 118. As indicated by block 120, the client parses the XML request using the client's web host programs. In this embodiment, both the web server 38 and the implementor server 42 use suitable programs which enable the servers to incorporate data from XML files into HTML files. These programs also enable the web server 38 to display the data in an HTML web page.

FIG. 9 illustrates the interaction and exchange of data between two client browsers in one embodiment of the present invention. As indicated by block 122, a user views an original client browser and then opens a new client browser. For example, the original browser may prompt the user to enter personal contact information. After doing so, a new browser may appear which enables the user to enter the user's insurance-related information, such as health history. As indicated by block 124, the new client browser then receives predetermined parameters or data from the original browser. As indicated by block 126, the new client browser then generates and sends an XML request to the implementor server, the implementor server then sends an XML response to the new client browser, and finally the new client browser parses out the XML data. The new client browser then sets predetermined values, parameters or data on the original browser, as indicated by block 128.

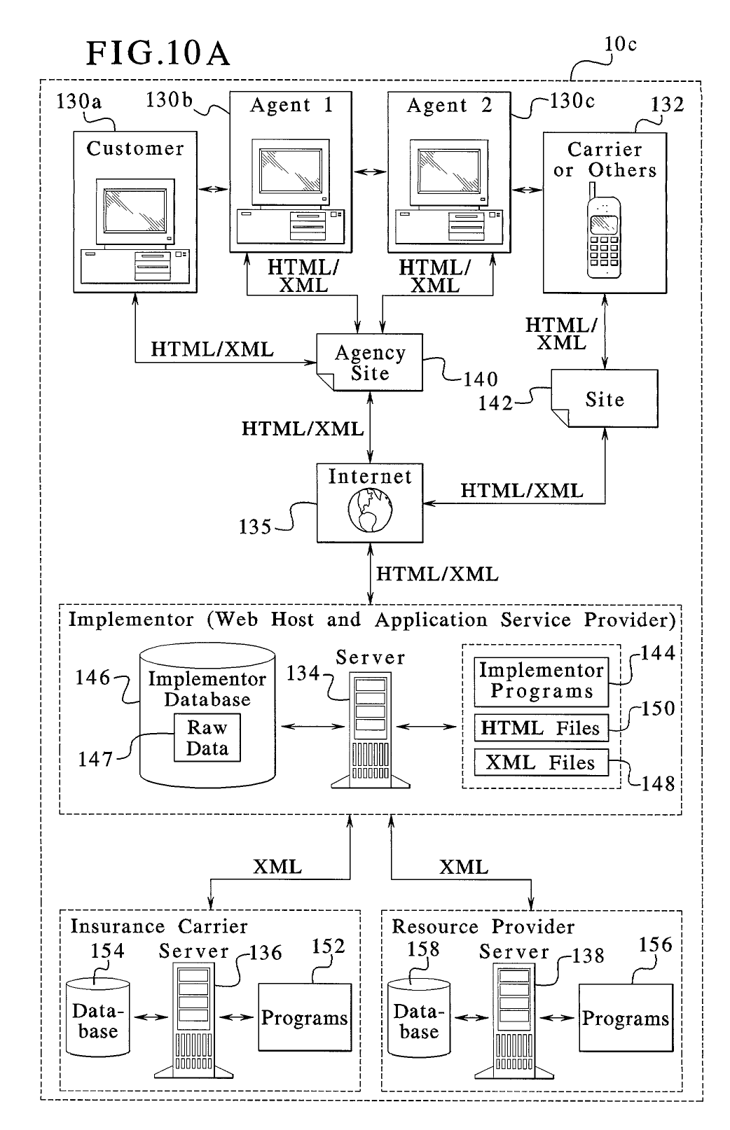

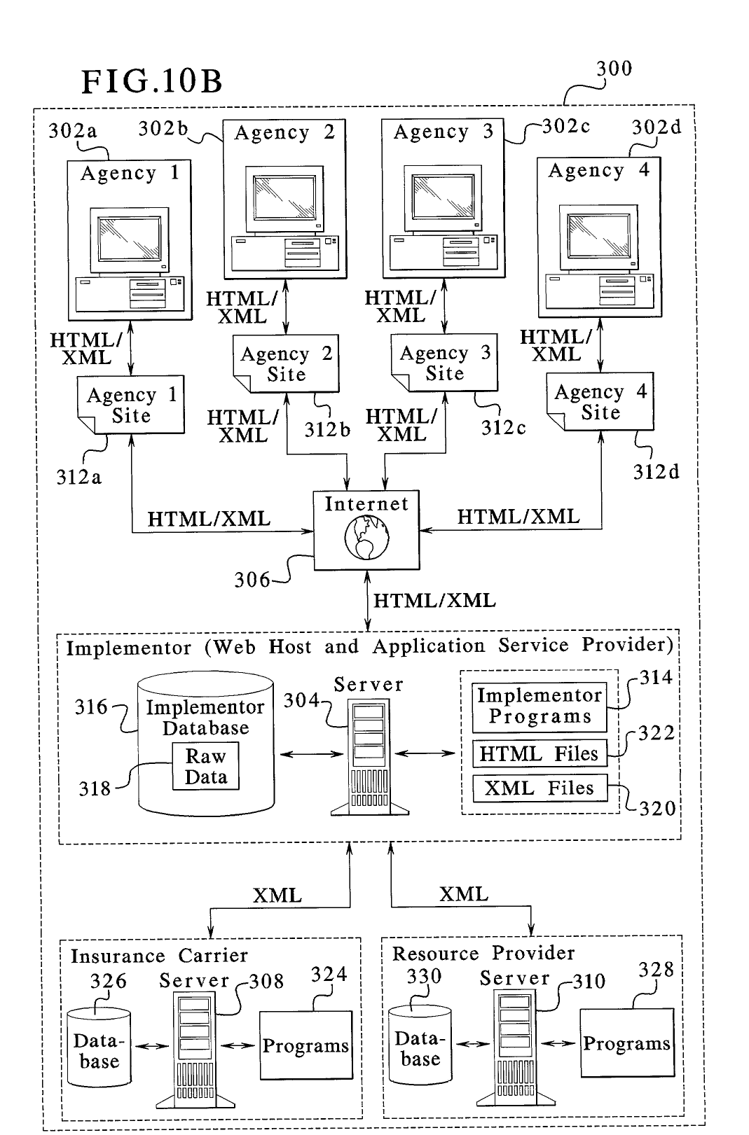

In one embodiment illustrated in FIG. 10A, a single server provides the functionality of both the web server and the implementor server required by the network architecture of the present invention. Here, network architecture 10c includes: (a) computers 130a, 130b and 130c and wireless telephone 132 connected to implementor server 134 over the Internet 135; (b) at least one carrier server 136 connected to the implementor server 134 over the Internet 135; and (c) preferably at least one resource server 138 connected to the implementor server 134 over the Internet 135.

Implementor server 134 hosts an agency website 140, and a website 142 of a carrier or any other party. Implementor server 134 also uses implementor programs 144 and implementor database 146 to process, generate and store raw data 147, XML files 148 and HTML files 150. In addition, carrier server 136 uses programs 152 and database 154 to process XML files, and resource server 138 uses programs 156 and database 158 to process XML files. In this embodiment, the implementor of the present invention functions as a web host for agencies, a conduit between agencies and carriers, as well as an application service provider for agencies, as described below in the description of the management system.

FIG. 10B illustrates the functionality of the implementor as an Application Service Provider (ASP) in one embodiment of the present invention. Here, network architecture 300 includes: (a) computers 302a, 302b, 302c and 302d connected to implementor server 304 over the Internet 306; (b) at least one carrier server 308 connected to the implementor server 304 over the Internet 306; and (c) preferably at least one resource server 310 connected to the implementor server 304 over the Internet 306.

Each agency has its own website. Implementor server 304 hosts agency websites 312a, 312b, 312c and 312d, where each such website is the website of agency one, agency two, agency three and agency four, respectively. Implementor server 304 also uses implementor programs 314 and implementor database 316 to process, generate and store raw data 318, XML files 320 and HTML files 322. In addition, carrier server 308 uses programs 324 and database 326 to process XML files, and resource server 310 uses programs 328 and database 330 to process XML files.

FIG. 10B illustrates that various agencies or other parties can use the implementor programs to perform insurance transactions and to operate and manage agency businesses. The computers of the agencies can directly communicate with the implementor server and use the implementor programs without the use of any programs other than a standard, preferably commercially or publicly available browser program which allows for XML data transfers. It should be appreciated that the network architecture in this embodiment enables a client computer (having the use of a suitable browser program) to directly communicate with the implementor server in order to enable insurance agents to conduct transactions and perform agency management activities.

The client computers all use the same implementor program which are available through the Internet. Though the different agencies use the same implementor programs, the unique insurance data associated with each agency is either stored in separate tables or separate portions of the implementor database 316, or the insurance data of each agency is stored in separate implementor databases altogether. Insurance agencies thus have an on-line system which provides them with their own electronic management files as well as a manner to electronically conduct insurance transactions.

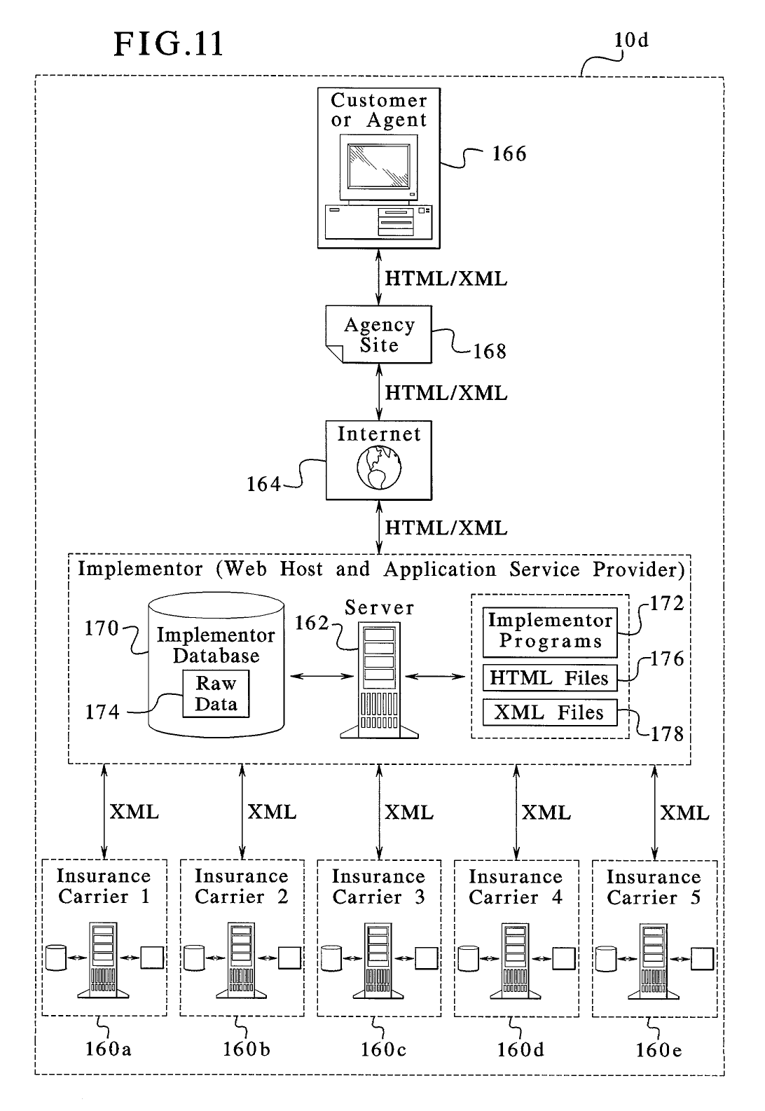

As illustrated in FIG. 11, one embodiment of the present invention the network architecture includes a plurality of different insurance carrier servers 160a through 160e which are connected to the implementor server 162 over the Internet 164. A customer or agent computer 166 accesses the implementor server 162 through an agency site 168 hosted by the implementor server 162. The server 162 communicates with database 170 and programs 172 to process raw data 174, HTML files 176 and to generate XML files 178. In this embodiment, a customer can use an independent agent's website to first obtain quotes by different insurance carriers. The customer can then compare quotes and purchase a policy from a desired carrier on-line, through the agent's website. This embodiment enables independent insurance agents and the like to conveniently market and sell policies from different insurance carriers on-line. The use of XML files enables the different carrier servers to conduct insurance transactions for the agents regardless of the particular platform, hardware type or software type used by the carrier servers.

In the preferred embodiment of the present invention, the standardized data format is XML files or XML data. It should be appreciated that XML files can include any version of XML, including without limitation, XML 1.0. Furthermore, it should be appreciated that the present invention can function by using a plurality of data formats and data structures and associated languages and programs which are currently being developed by the World Wide Web Consortium and other parties to function in conjunction with XML, to compliment XML, to enhance XML, or to provide a substitute for XML, including without limitation: (a) Xlink which describes a standard way to add hyperlinks to an XML file; (b) XPointer and Xfragments which are syntaxes for pointing to parts of an XML document; (c) CSS, a style sheet language applicable to XML as it is to HTML; (d) XSL, an advanced language for expressing style sheets; (e) XSLT, a supporting language for XSL which is often useful outside of XSL as well, for rearranging, adding or deleting tags and attributes; (f) DOM which is a standard set of function calls for manipulating XML (and HTML) files for programming language; (g) XML Namespaces, which is a specification which describes how to associate a Uniform Resource Locator (URL) with every single tag and attribute in an XML document or file; (h) XML Schemas 1 and 2 which help developers to precisely define their own XML-based formats; and (i) various other modules and tools which are currently being developed. It should also be appreciated that the present invention can operate without XML. For example, the present invention can operate with Standard Generalized Markup Language (SGML) or any language based upon SGML.

### B. Use by Agents and Others

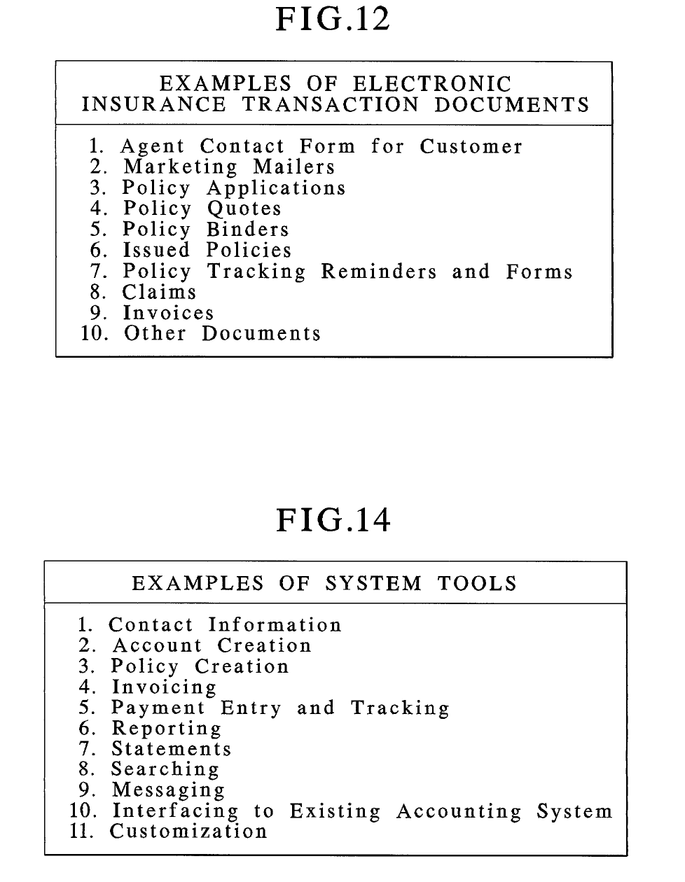

The network architecture of the present invention enables multiple agents, affiliates, customers and carriers to seamlessly transfer information to and from one another regarding insurance transactions. The server request code and database request code specify a plurality of different types of electronic insurance transaction documents which the implementor server can exchange between user computers and carrier or resource servers. For example, as illustrated in FIG. 12, these documents preferably include: (a) an agent contact form which customers can use to contact agents; (b) marketing mailers; (c) policy applications for collecting customer information; (d) policy quotes; (e) policy binders (which ensure coverage pending payment by customers); (f) issued policies; (g) policy tracking reminders and forms; (h) claims; (i) invoices; and (j) other documents or forms. All of these documents can be exchanged as standardized data, such as XML files, between agents, affiliates, customers, carriers and others over a network, such as the Internet. The implementor server preferably uses the management code, described below, to track all of the data associated with these transactions.

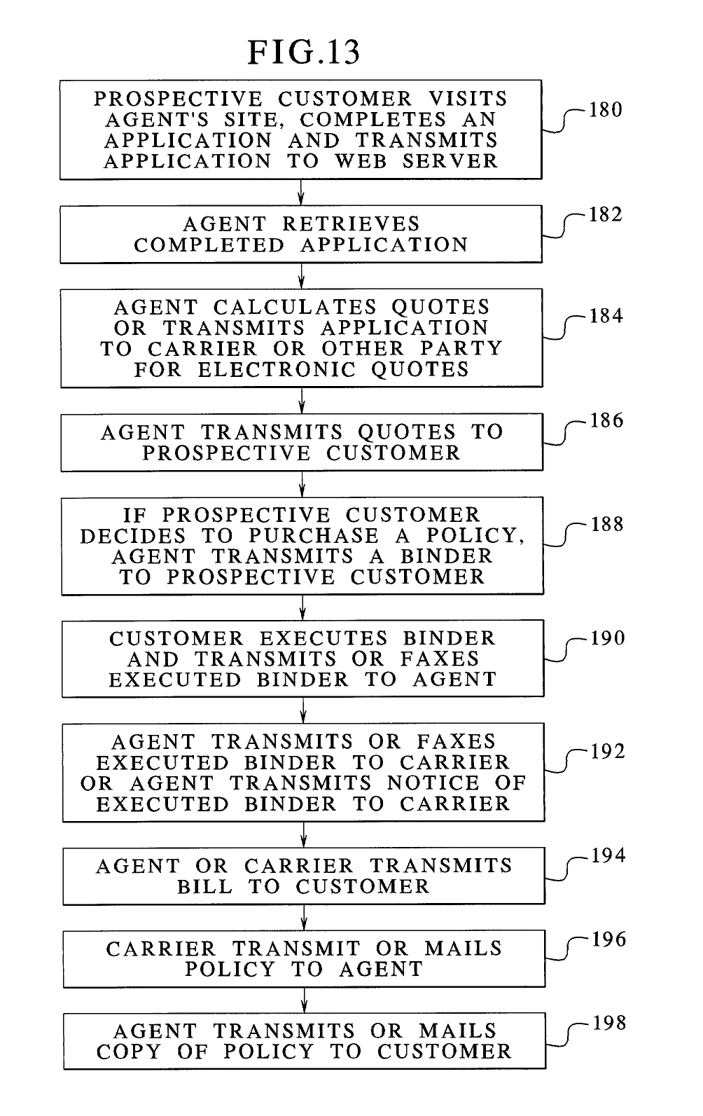

As illustrated in FIG. 13, in one example a prospective customer visits an agent's or an agency's website, completes a policy application available at that website and then transmits that application to the web server which is hosting the agency website, as indicated by block 180. An agent then, accessing his/her agency's website, would receive the completed application, as indicated by block 182. The agent may personally calculate quotes, granted that the agent has the authority to do so, or the agent may transmit the application to carriers or other parties in order to obtain electronic quotes, as indicated by block 184. Upon receiving the electronic quotes, the agent can forward or transmit the quotes to the prospective customer, as indicated by block 186. Up to this point, the network architecture of the present invention has enabled a customer to submit an application for quotes from different carriers, and an agent has obtained quotes from carriers and provided those quotes to the customer without the use of paper faxing. It should be appreciated, however, that the agent may desire to contact the prospective customer over the phone at any time to establish a more personal relationship with the prospective customer.

If the prospective customer decides to purchase a policy from a particular carrier, the agent can transmit a binder to the prospective customer, as indicated by block 188. As indicated by block 190, the customer can execute or sign the binder electronically through the use of suitable encryption technology, in accordance with the federal and state electronic signature laws. Alternatively, the customer can print and physically sign the document, scan the signature page of the document and transmit the scanned image to the agent. Of course, the customer can instead print and physically sign the binder and fax, mail or otherwise send the binder to the agent.

As indicated by block 192, the agent can then electronically transmit the binder to the carrier, or the agent can electronically transmit notice of the executed binder to the carrier. The agent or the carrier can then transmit a bill or invoice to the customer for payment, as indicated by block 194. The carrier can then electronically transmit the actual policy to the agent, or the carrier can fax or mail a copy of the policy to the agent, as indicated by block 196. As indicated by block 198, the agent can then electronically transmit, fax or mail a copy of the policy to the customer. Preferably, when the customer is using the agency website to obtain a quote, perform a purchase or perform other activities, the customer is not aware that the implementor server has obtained information from carrier servers or resource servers. It is preferable that, from the customer's viewpoint, the agency website is, by itself, providing the customer with the requested information and services.

Though not illustrated in FIGS. 1, 3, 10 or 11, it should be appreciated that the network architecture of the present invention can include a plurality of agency websites with a web server hosting each website. In addition, agents, affiliates of agents, customers and carriers can all access any of these websites in order to use the implementor server to perform insurance transactions. Also, the network architecture can include websites designated for parties other than agents, such as carrier websites, affiliate websites and even customer websites. For instance, if a customer is a company or organization, the company or organization may have a benefits or insurance website which enables agents and insurance carriers to provide insurance services for the company's or the organization's employees.

In an alternative embodiment of the network architecture of the present invention, the network architecture includes: (a) one or more computers connected to the implementor server through a network; (b) at least one third party server connected to the implementor server through the network; and (c) at least one insurance carrier server connected to the third party server through the network. Here, the implementor server exchanges insurance-related data (such as XML files) with the carrier server, indirectly through the third party server. The third party server receives a request from the implementor server and transmits that request to one or more carrier servers. The carrier servers return a response to the third party server, and the third party server transmits this response to the implementor server. The implementor server then transmits the response to a client computer or other network access device.

### II. Management System

The management system or system of the present invention, which is preferably supported by the network architecture, enables agents, agencies, affiliates and others to conveniently, efficiently and effectively manage their insurance business. In one embodiment, the system includes: (a) a server (preferably the implementor server) operating on a network, preferably the Internet; (b) at least one database (preferably the implementor database) connected to the server; and (c) management code which is suitable for instructing the server to store, organize, manipulate, calculate, generate, transmit and track certain insurance-related data.

The management code, program or application includes a plurality of electronic management tools. As illustrated in FIG. 14, these tools preferably generally include tools for managing contact information, creating accounts, creating policies, creating invoices, entering payments and tracking payments and other transactions, generating reports, graphs and tables, generating statements, searching for information and data, posting messages to and from agents and affiliates, interfacing with existing accounting systems, and enabling users to customize graphical interfaces and other aspects of the tools. It should be appreciated the management code can include any other suitable tool which is useful to insurance agents or other users of the system.

In one embodiment, when an agent enters data using these management tools, the implementor server stores the data within the implementor database. Preferably, the management code instructs the implementor to relationally organize the data in the implementor database. It is preferable that the implementor database be a relational database including a plurality of related data tables for storing data. The management code is preferably based upon business logic or other suitable logic which enables the implementor processor to perform complex mathematical calculations and data manipulations using the relationally organized data. In this manner, the implementor server retrieves certain data from a carrier server, for example. The implementor server then determines the type of data retrieved and stores it in a table designated for that data. For example, if the data is a payment from a carrier to an agent, the implementor server would store this data in a payment table. The implementor server can track the data associated with different transactions in this manner. The implementor server could also download certain data, such as payment data, to an agent's existing accounting or payment software.

In operation of one embodiment of the system, an agent or other user must first open an account with the implementor of the system. The implementor then provides the user with a user name and password necessary to use the system. To use the system, the user must log onto the Internet and link to the user's website, a website specifically designated for the user and hosted by the implementor server. By entering the user's user name and password, the user can access a home page and a plurality of other web pages. The user can manage his/her insurance transactions and business by performing various functions presented on these web pages.

It should be appreciated that the management system in one embodiment serves as both an on-line electronic filing and organization system as well as an on-line conduit for electronically sending requests and receiving responses to and from insurance carriers and insurance resource providers.

The management system serves as a conduit when it is supported by the network architecture which allows for the transfer of standardized data (preferably XML files) between client computers, the implementor server and insurance carrier servers. Whenever an XML-based transaction occurs, the management system tracks the transaction. Specifically, the management code instructs the implementor server to store certain data (in raw form or in XML file form) in a database. The server can then retrieve this data in response to requests by users at a later time. This enables a user to generate a report which displays the policies sold by the agent within the last three months, for example.

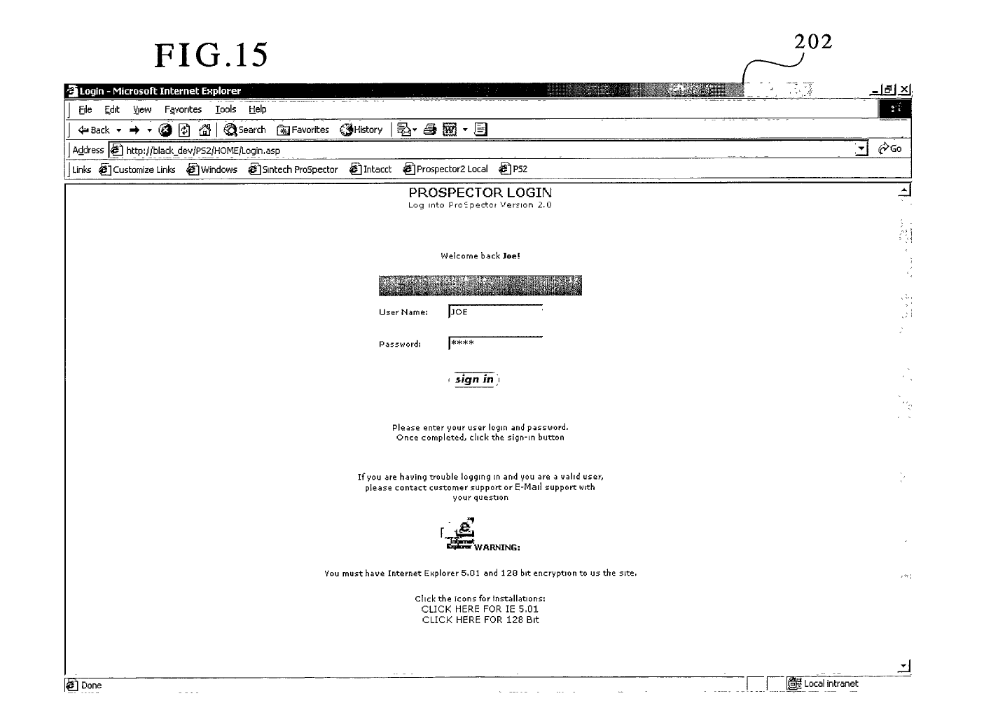

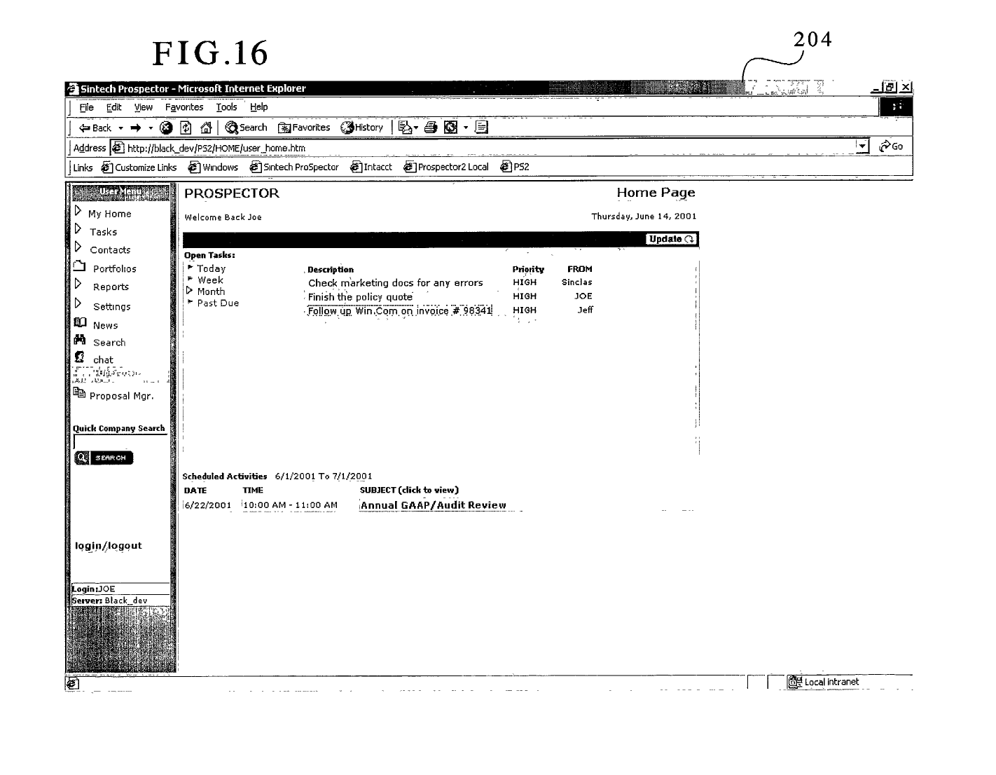

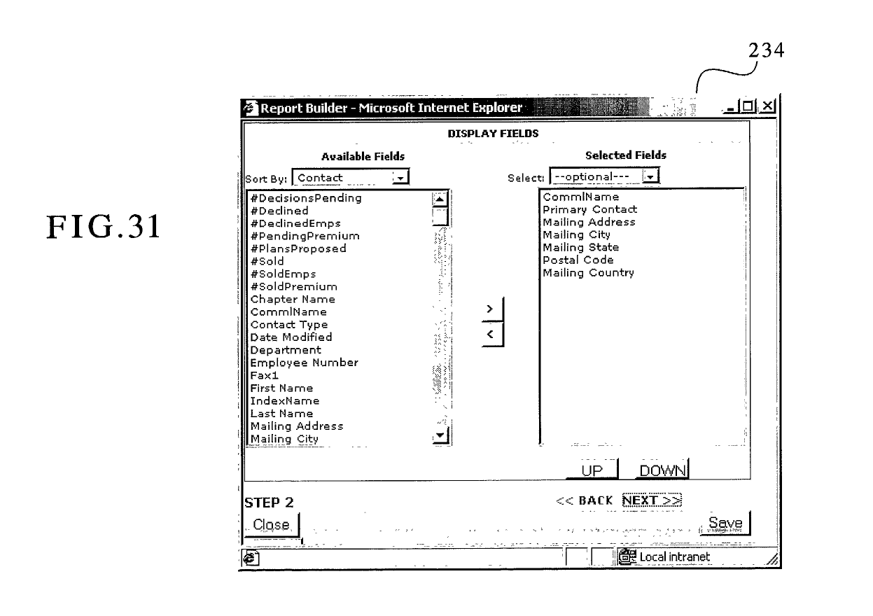

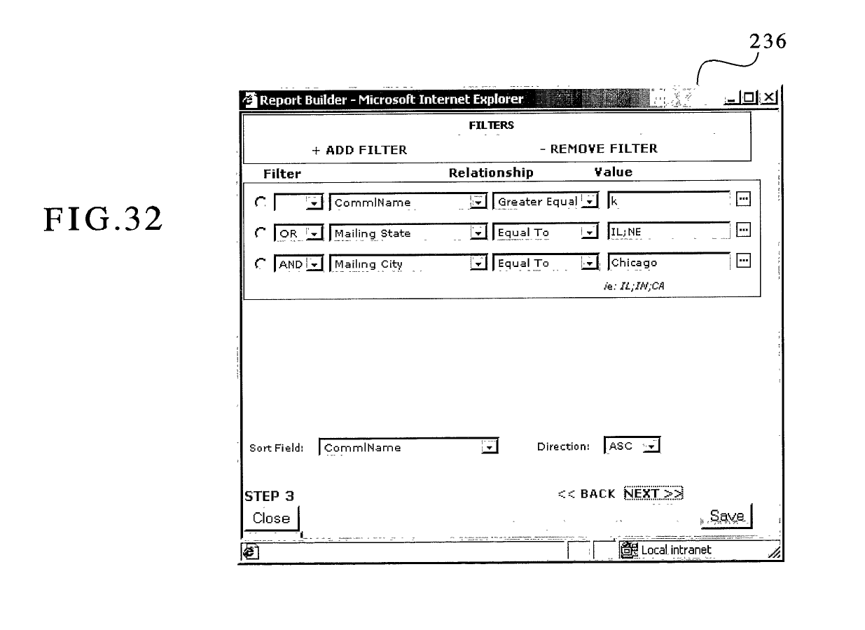

FIGS. 15 through 35 illustrate example interfaces or screen shots viewed by a user in one embodiment of the system of the present invention. FIG. 15 illustrates a login page 202 which is accessible at the user's website. Login page 202 enables authorized users to securely access their website by entering a username and password. A home page 204, illustrated in FIG. 16, provides users with a snapshot of their current action items related to their business. The home page 204 can display a list of unbound policies, invoices due within the next seven days and policies which are expiring within the next thirty days. It should be appreciated that the home page 204 can be customized for users based upon their particular needs.

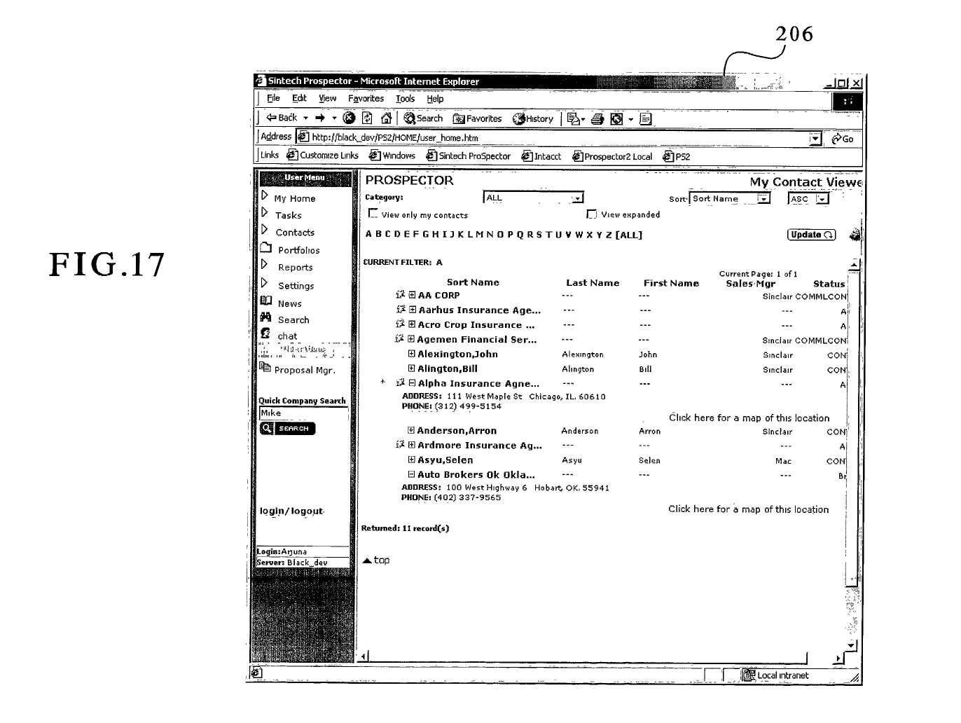

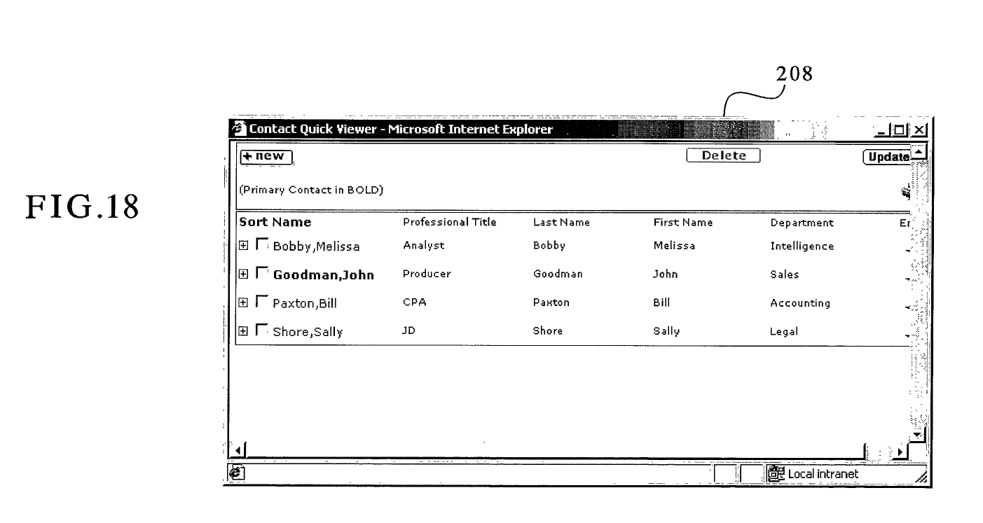

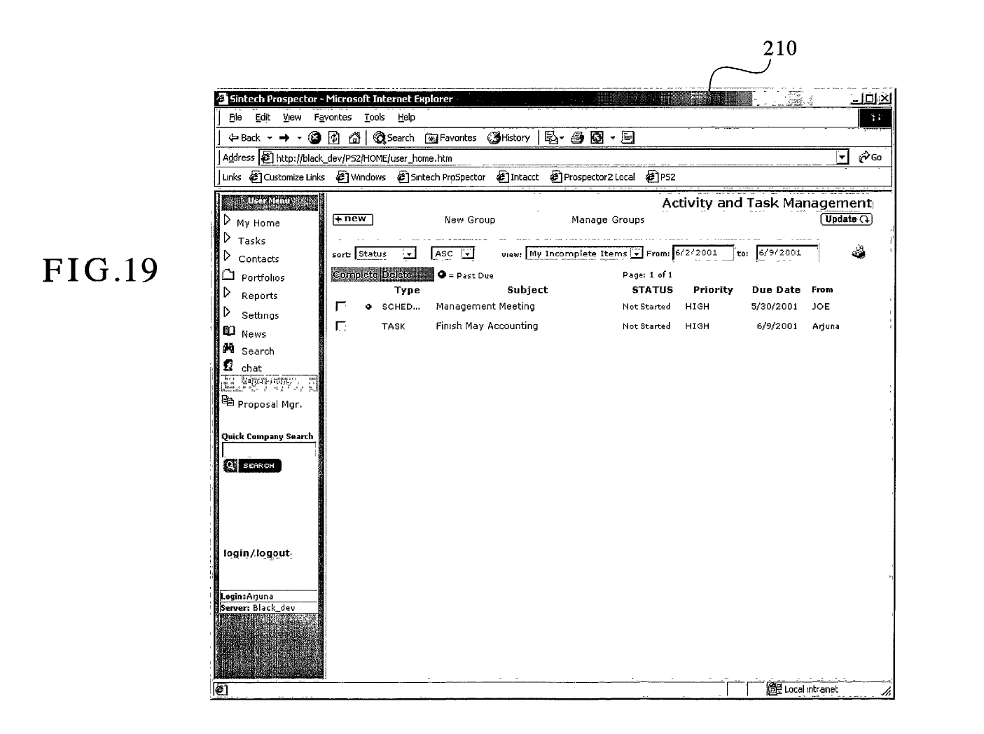

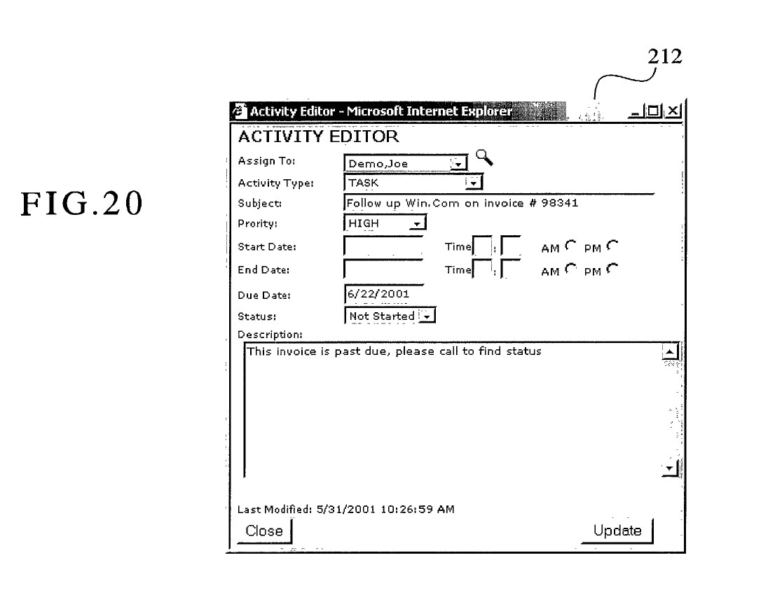

FIG. 17 illustrates a contact manager page 206. The contact manager page 206 displays all of the entities with which the users do business. Users can filter the views to display agencies, carriers, insured customers and prospective customers to whom they have quoted and/or written business. By clicking on a contact, users can view and edit detailed information related to the contact, as illustrated by screen shot 208 in FIG. 18. A task page 210 and activity page 212, illustrated in FIGS. 19 and 20, enable users to track and prioritize their activities.

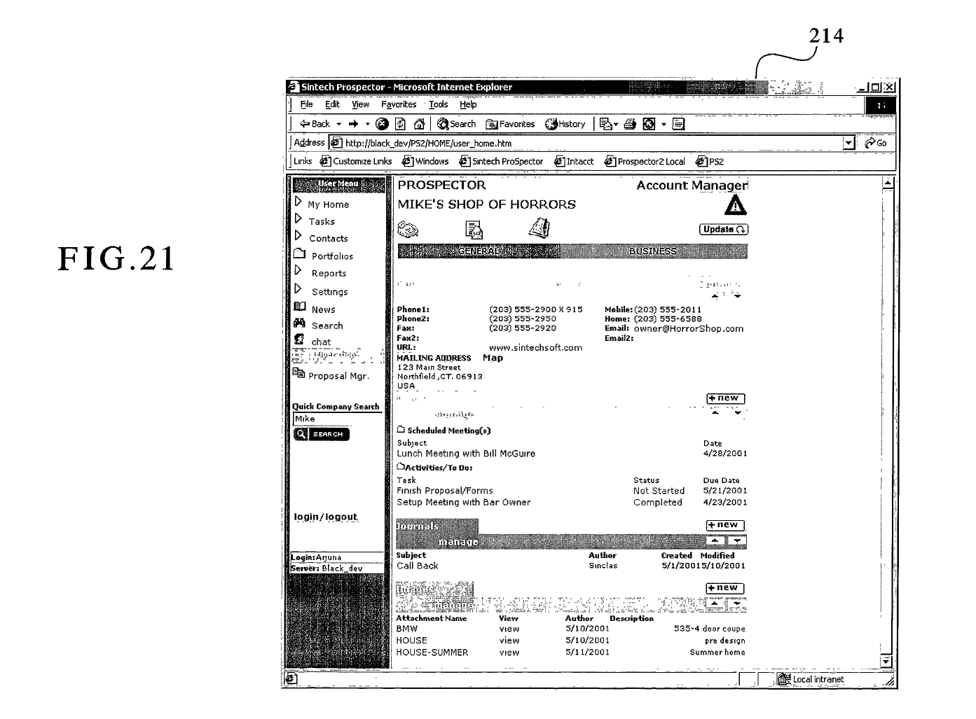

Account manager page 214, illustrated in FIG. 21, enables users to view the people they deal with at the particular contact company, the policies they have quoted or written, the invoices they have issued and the payments on those invoices. The account manager page 214 also enables users to enter claims on specific policies.

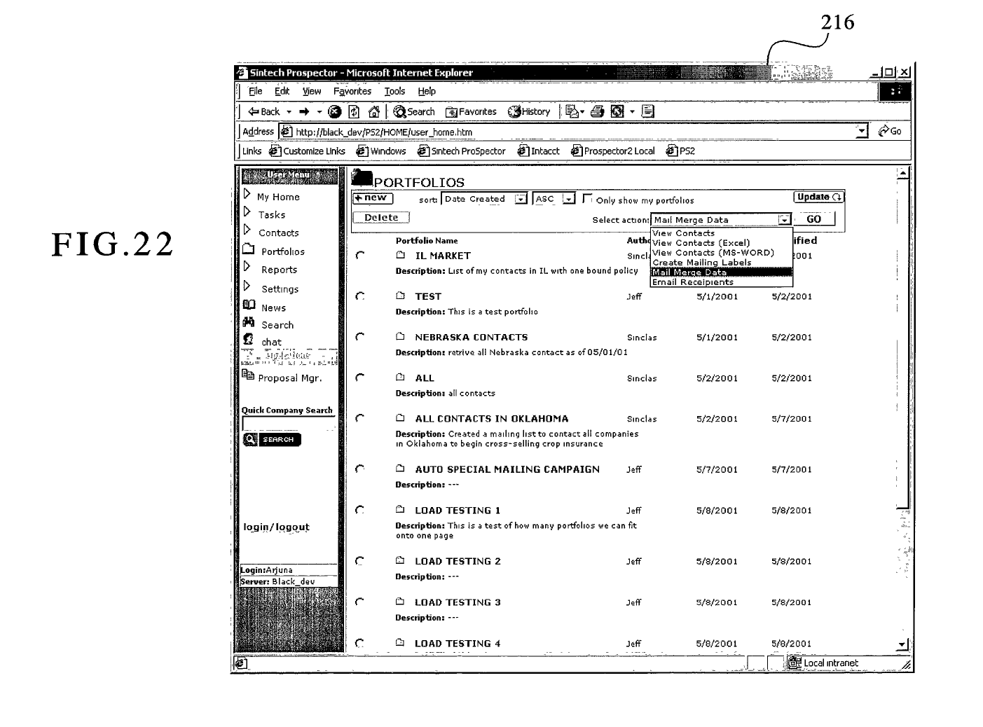

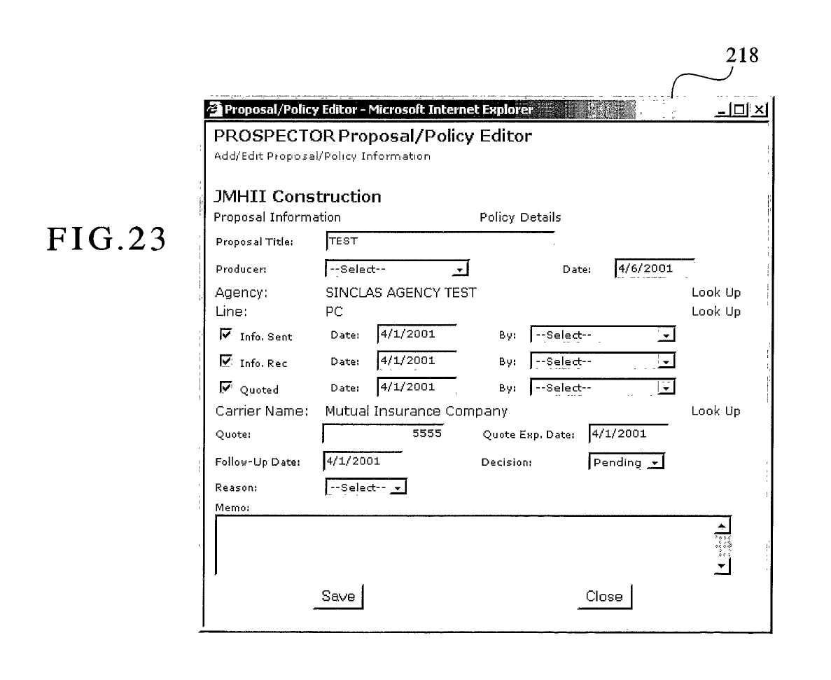

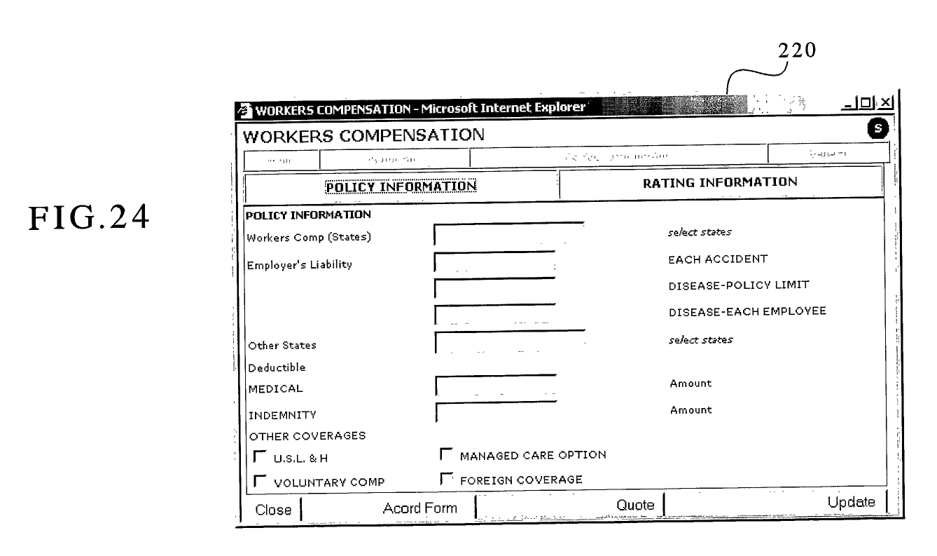

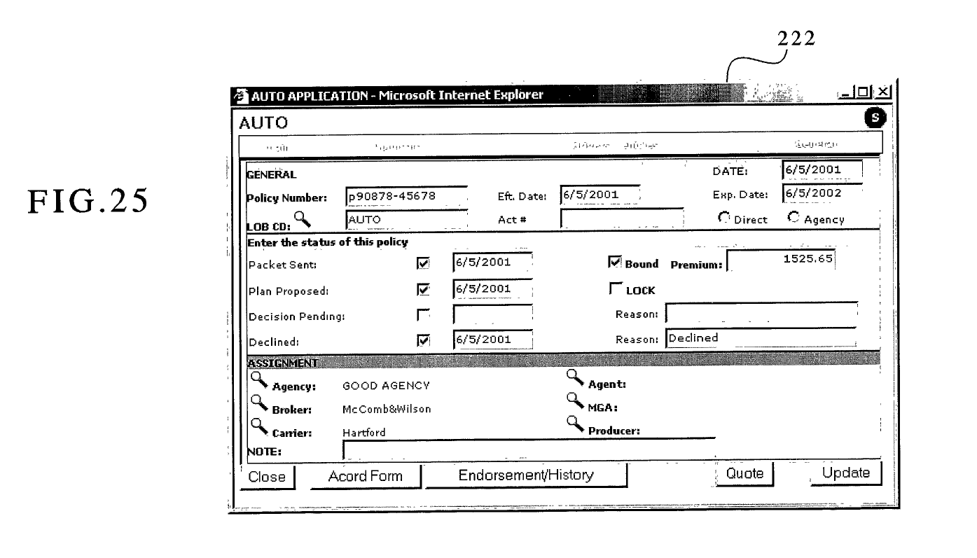

Portfolio page 216, illustrated in FIG. 22, enables users to view their entire policy portfolio or detailed portions of their portfolio. The user can enter policy information in a general policy page 218, as illustrated in FIG. 23. Alternatively, users can use specific policy pages, such as the workers compensation policy page 220 or the auto policy page 222 illustrated in FIGS. 24 and 25, respectively. In any case, those pages enable users to manage their policies in a relatively time efficient and convenient manner over the Internet. Users can edit policy information and create new policies as customers request quotes. Policy information is viewable by type, such as main information, by applicant, rating information and general information.

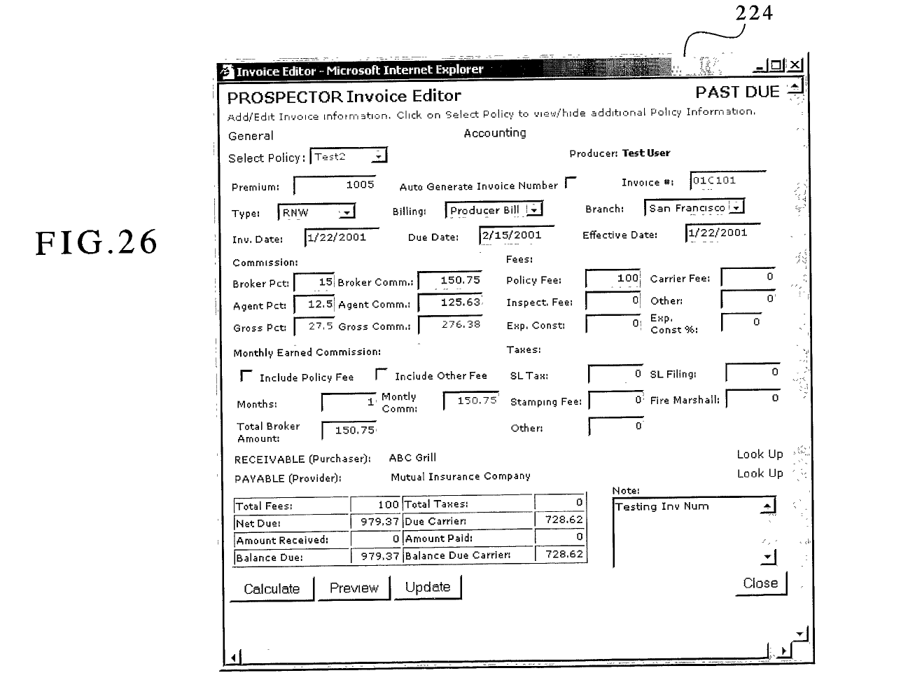

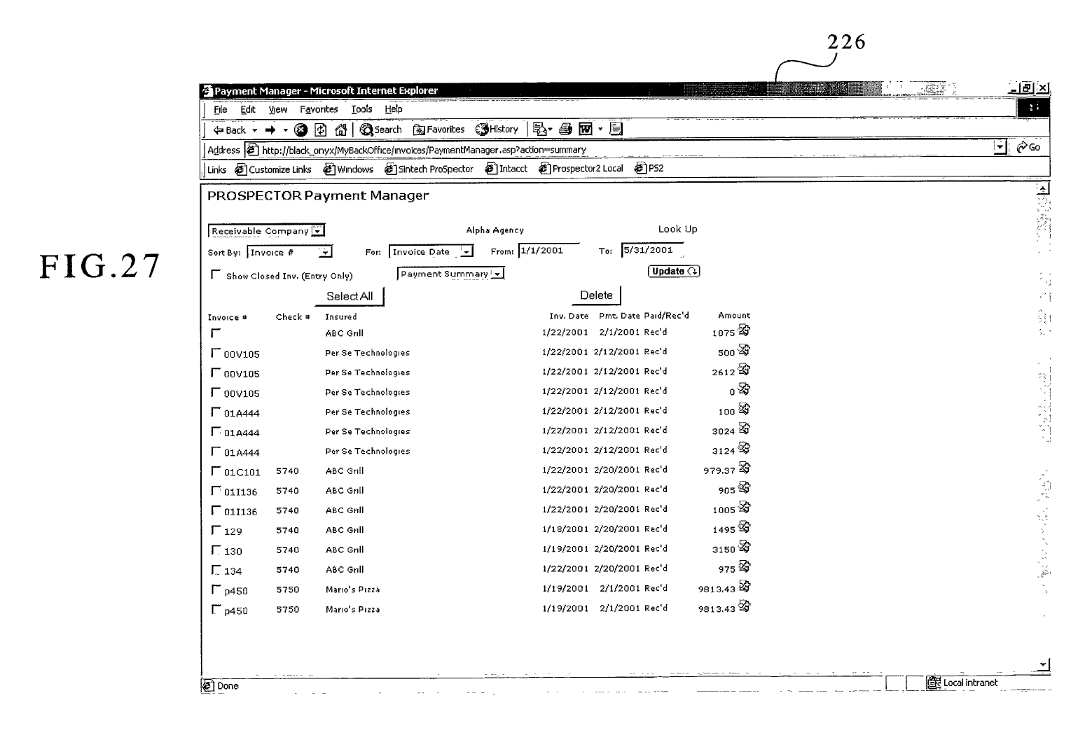

The invoice information page 224, illustrated in FIG. 26, enables users to create and manage invoices using a flexible, multipurpose or customizable interface. The invoice information page 224 enables users to enter basic invoice information with instant calculation upon entry. Payment management page 226, illustrated in FIG. 27, enables users to manage payments they receive from agents or customers. The payment management page 226 also enables users to make payments to providers. Users can use the payment management page 226 to make bulk payment in a relatively time efficient manner.

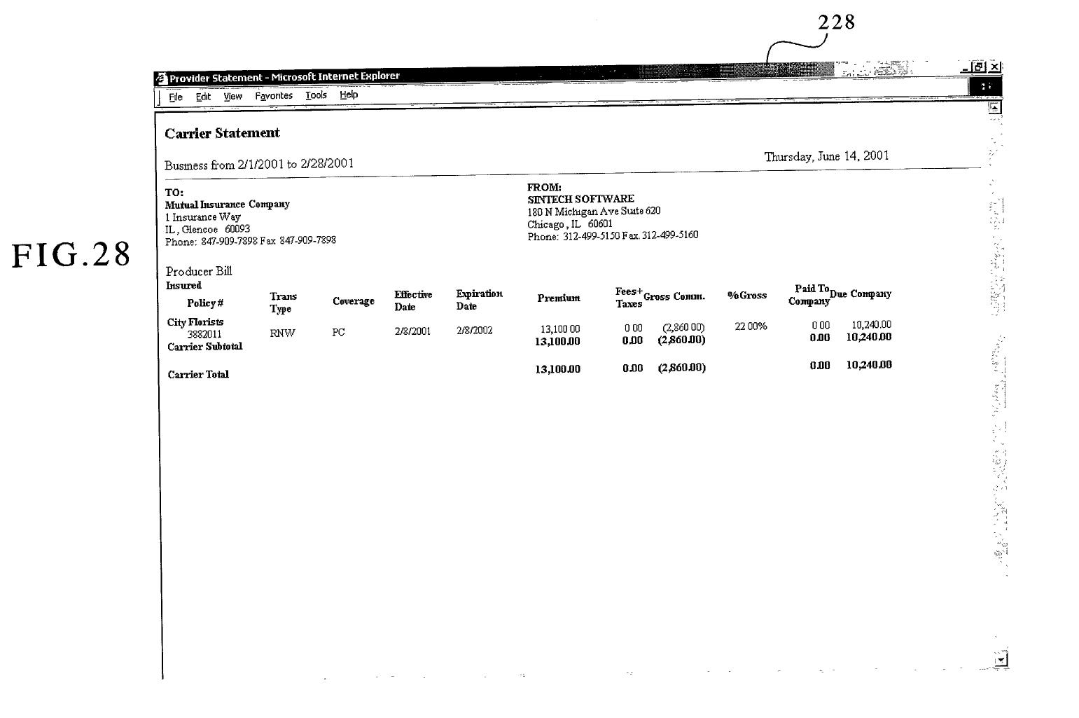

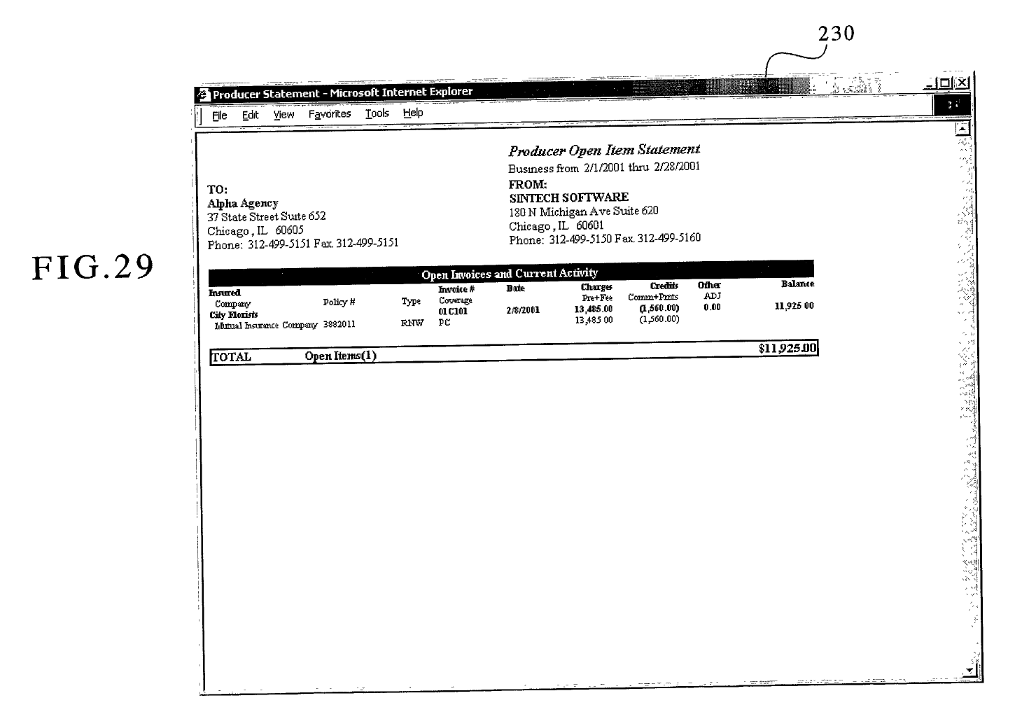

Users can create statements for carriers and producers, as illustrated in the carrier statement page 228 shown in FIG. 28 and the producer statement page 230 shown in FIG. 29. The statement pages 228 and 230 enable users to create statements in real time for insurance carriers or providers and affiliated agents who are producers. Agents can create one statement or use a batch-reporting feature to create statements for all of their providers or producers. Users can save the reports to the hard drives of their computers with relative ease for archiving and printing purposes. Users can also enable providers and producers to log on to the users' websites to view provider and producer statements over the web.

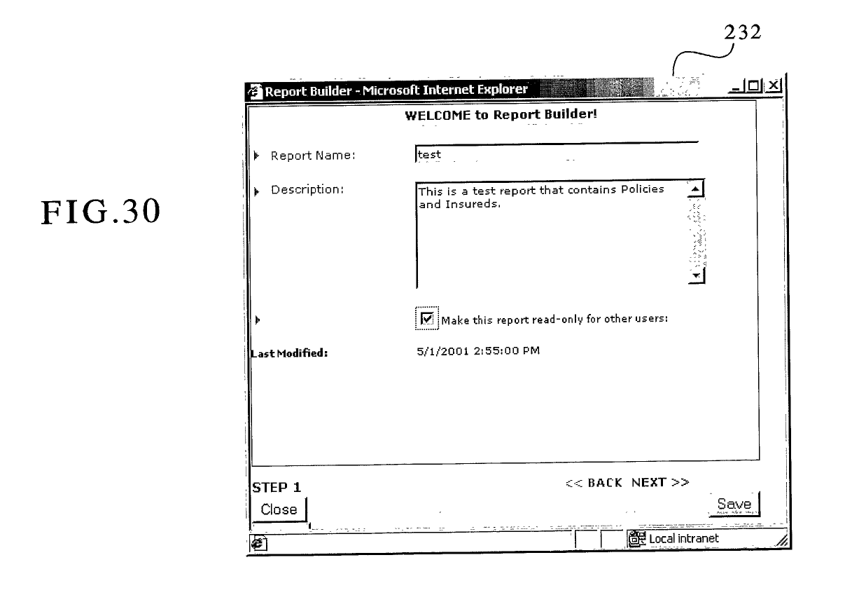

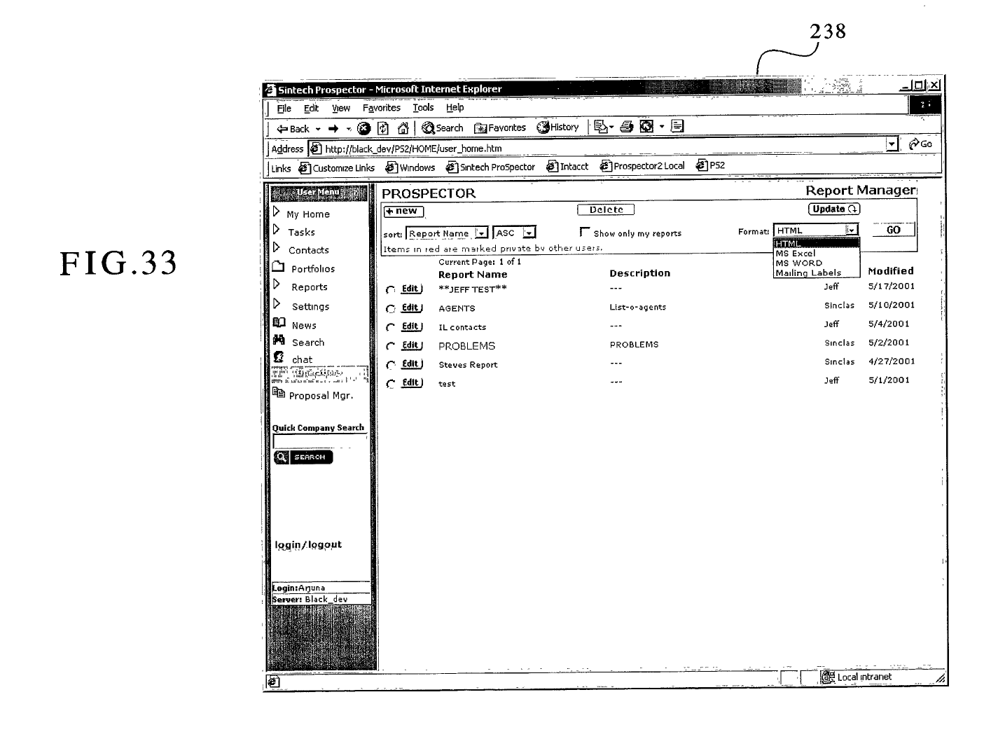

Custom report pages 232, 234 and 236, as illustrated in FIGS. 30, 31 and 32, enable users to generate and customize various reports for the management of their agency business. Report manager page 238, illustrated in FIG. 33, enables users to organize and store various reports they have generated for future viewing or printing. Report manager page 238 also enables users to generate different types of reports, graphs, tables and information, depending upon the user's specific needs. Users can also define the type of content they want to view and select the view format.

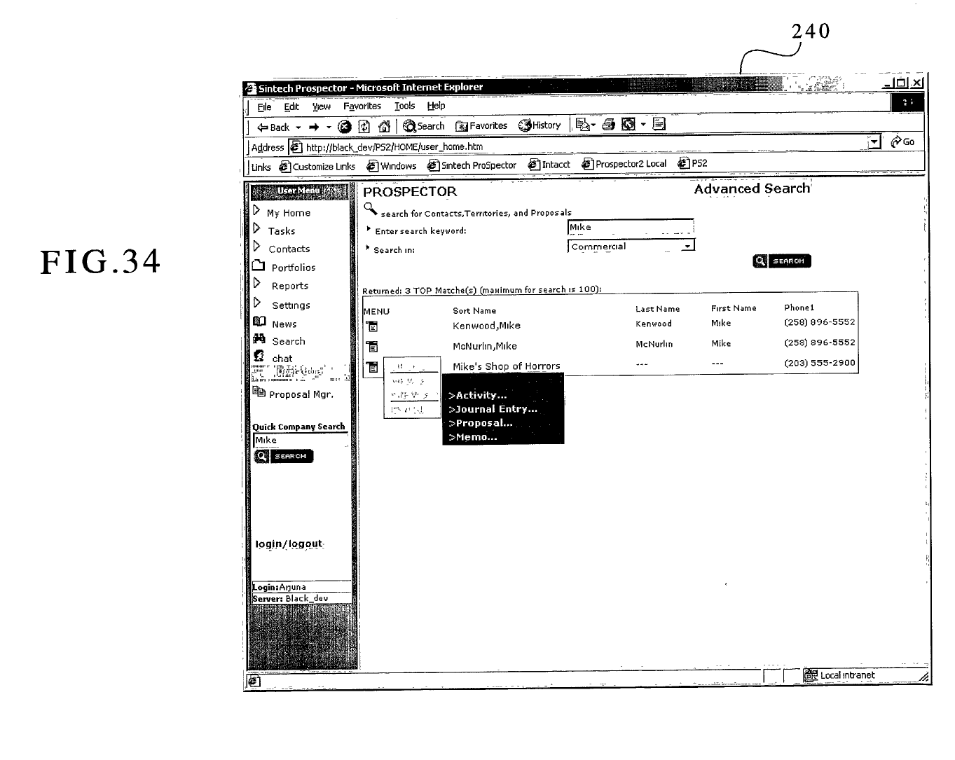

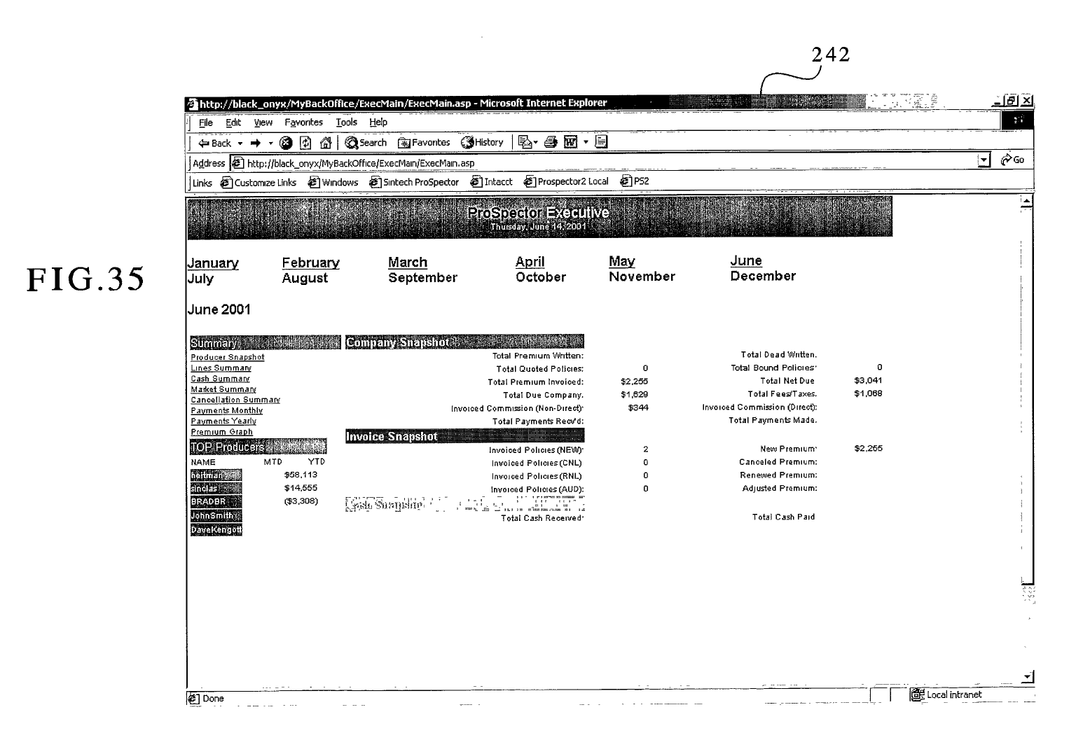

A finder page 240, illustrated in FIG. 34, enables users to effectively and efficiently search for and locate policy, invoice or contact information. Executive summary page 242, illustrated in FIG. 35, enables users to assimilate the data which is stored by the system in an executive-level overview. Executive summary page 242 provides users and business managers with a relatively concise summary of how the user's business is operating on a month-to-month basis.

The system also preferably includes a messenger page which enables users to post messages to other users on the Internet. Users can send and receive messages to and from co-workers at a particular company or to other companies. For example, users can send and receive messages to and from insurance carriers and agent affiliates who log onto the user's website to view their statements.

In addition, the system preferably includes a system integration page which enables users to create programming interfaces between the system and other systems the user is using. For example, these interfaces can enable users to create files which can be uploaded to the user's existing accounting system.

It is also preferable that the system includes a chat page which enables multiple users, carriers and producers to simultaneously communicate with one another. The system can also include a business review page which enables users to analyze and view their business in real time. Users can view payments on policies, sort their policies and invoices by date or size and view how much business they have written with providers.

The management system of the present invention, in one embodiment, provides agents with a convenient, on-line system for managing their insurance business. When supported by the network architecture of the present invention, the management system automatically records transactional data and integrates this data into user friendly management tools. These tools enable users to operate and manage all aspects of their business.

It should be appreciated that the system can include web pages, spread sheets, forms and documents not specifically illustrated in FIGS. 15 through 35. For example, the system preferably includes web pages which enable users to enter and track user information such as information regarding the employees of an agency. The system also preferably includes web pages which enable users to customize the look and functionality of their website. Also, the management code can include instructions and tools which enable agents to draft and process checks.

In one embodiment the system includes a claims notice tool which notifies agents and/or carriers of accidents, deaths, fires or other events which may result in an insurance claim. In this embodiment, it is preferable that an insured person, automobile, building or other property is electronically connected to or monitored by an onboard or otherwise portable electronic device which is connected to the Internet or another network. Such an electronic device is preferably programmed to transmit a claims notice through the Internet or network when a predetermined event occurs. The management code includes suitable claims notice code or instructions which instruct the implementor server to notify an agent or carrier when such a predetermined event occurs. The server preferably provides the notice by posting a message to an agent's website or sending a message to any output device connected to a carrier's server. The management code can also be adapted to instruct the implementor server to notify agents or carriers when a particular news event or other predefined event occurs which suggests that one or more insurance claims will likely be made. For example, if a fire, flood or multiple automobile accident occurs, the management code can instruct the implementor server or another server to electronically search for a report of such an event in publicly available information on the Internet. The management code can then instruct the implementor server to notify an agent or carrier of such an event when such a report is found.

The network architecture and management system, in one embodiment of the present invention, includes a client/server/server architecture supporting a management system which enables agents and others to electronically conduct insurance transactions (such as policy purchases) with insurance carriers and customers. The network architecture supports the flow of standardized data, preferably XML files, from server to server. Agents can obtain quotes, sell policies and conduct other insurance transactions without having to exchange paper (through facsimile or otherwise) with insurance carriers. The network architecture and management system provide agents and others with an on-line system for managing their agency business, including the transactional, portfolio, marketing and accounting aspects of their business. The network architecture and management system of the present invention enables the insurance industry to perform activities with increased convenience, efficiency and effectiveness.

While the present invention has been described in connection with what is presently considered to be the most practical and preferred embodiments, it is to be understood that the invention is not limited to the disclosed embodiments, but on the contrary is intended to cover various modifications and equivalent arrangements included within the spirit and scope of the claims. It is thus to be understood that modifications and variations in the present invention may be made without departing from the novel aspects of this invention as defined in the claims, and that this application is to be limited only by the scope of the claims.

What is claimed is:

1. A method for facilitating insurance industry activities over an electronic data network, said method comprising the steps of:
(a) receiving non-standardized insurance request data from a client computer over the network;
(b) generating standardized insurance request data from the non-standardized insurance request data;
(c) transmitting the standardized insurance request data to at least one insurance carrier server over the data network;
(d) receiving standardized insurance response data from the insurance carrier server over the data network; and
(e) transmitting the standardized insurance response data to the client computer over the data network.

2. The method of claim 1, which includes the step of indirectly transmitting the standardized request data to at least one insurance carrier server over the data network.

3. The method of claim 2, which includes the step of directly transmitting the standardized request data to at least one second server which is electronically connected to the data network.

4. The method of claim 3, which includes the steps of receiving standardized insurance response data from the second server over the data network and transmitting the standardized insurance response data to the client computer over the data network.

5. The method of claim 1, which includes the step of transmitting the standardized request data to at least one resource server over the data network.

6. The method of claim 5, which includes the steps of receiving standardized insurance resource response data from the resource server over the data network and transmitting the standardized insurance resource response data to the client computer over the data network.

7. A method for performing insurance transactions over an electronic data network, said method comprising the steps of:
(a) receiving an insurance data request from a client computer;
(b) standardizing the insurance data request;
(c) transmitting a standardized insurance data request to at least one insurance carrier server;
(d) receiving a standardized insurance data response from the insurance carrier server; and
(e) transmitting the standardized insurance data response to the client computer.

8. The method of claim 7, wherein the insurance data request includes an insurance policy application.

9. The method of claim 7, wherein the insurance data request includes a request for an insurance policy quote.

10. The method of claim 7, wherein the insurance data request includes a purchase of an insurance policy.

11. A method for facilitating insurance industry activities through an Internet, said method comprising the steps of:
(a) receiving an HTML request from a client computer, over the Internet;
(b) generating a first XML request based upon the HTML request;
(c) transmitting the first XML request from the first server to a plurality of insurance carrier servers over the Internet;
(d) receiving a carrier XML response from at least one of the insurance carrier servers over the Internet; and
(e) transmitting the carrier XML response to the client computer over the Internet.

12. The method of claim 11, which includes the step of receiving an HTML/XML request from the client computer over the Internet.

13. A method for facilitating insurance agency operation over an Internet, said method comprising the steps of:
(a) receiving an insurance data request from a client computer over the Internet;
(b) generating a first XML request based upon the insurance data request;
(c) transmitting the first XML request from the first server to at least one of a plurality of potential insurance carrier servers over the Internet;
(d) receiving a carrier XML response from at least one of the insurance carrier servers over the Internet; and
(e) transmitting the carrier XML response from the first server to the client computer over the Internet.

14. The method of claim 13, wherein the insurance data request is an HTML/XML request.

15. The method of claim 13, wherein the insurance data request is an XML request.

16. A method for facilitating insurance policy sales by insurance agents over an Internet, said method comprising the steps of:
(a) receiving an HTML/XML sell request from an agent's web browser over the Internet;
(b) generating an XML sell request based upon the HTML/XML sell request;
(c) transmitting the XML sell request from the first server to at least one of a plurality of potential insurance carrier servers over the Internet;
(d) receiving an XML sell response from at least one of the insurance carrier servers over the Internet; and
(e) transmitting the XML sell response to the insurance agent's web browser over the Internet.

17. A method for facilitating insurance policy purchases by insurance customers over an Internet, said method comprising the steps of:
(a) enabling a customer to electronically select one insurance policy out of a plurality of insurance policies offered by a plurality of different insurance carriers;
(b) receiving an HTML/XML purchase request from an insurance customer's web browser over the Internet;
(c) generating an XML purchase request based upon the HTML/XML purchase request;
(d) transmitting the XML purchase request to a particular insurance carrier server over the Internet;
(e) receiving an XML sale response from the particular insurance carrier server over the Internet; and
(f) transmitting the XML sale response to the customer's web browser over the Internet.

18. A method for facilitating insurance agency operation over an Internet, said method comprising the steps of:
(a) providing an insurance agency website which is accessible by a plurality of customer computers electronically connected the Internet;
(b) enabling insurance customers to transmit insurance data requests through the insurance agency website over the Internet;
(c) using a first server and a data storage device electronically connected thereto in order to receive the data requests over the Internet;
(d) using the first server and the data storage device to generate XML requests from the insurance data requests;
(e) using the first server to obtain XML responses from insurance carrier servers over the Internet; and
(f) using the first server to transmit the XML responses to the customer computers over the Internet.

19. A method for using a network architecture for conducting insurance industry activities over a network, said method comprising the steps of:
(a) electronically connecting a first server to the network;
(b) enabling at least one network access device to electronically connect to the first server;
(c) electronically connecting the first server to a plurality of insurance carrier servers over the network;
(d) electronically connecting a data storage device to the first server; and
(e) storing standardized insurance data generator code within the data storage device.

20. The method of claim 19, which includes the step of directly electronically connecting the first server to a plurality of insurance carrier servers over the network.

21. The method of claim 19, which includes the step of electronically connecting the first server to a plurality of insurance carrier servers through at least one second server which is electronically connected to the network.

22. A data storage device electronically connected to a server operating on a network, said data storage device comprising: a memory device storing a plurality of instructions which direct the server to:
(a) execute a plurality of predetermined insurance-related database requests;
(b) receive a plurality of predetermined types of insurance-related requests from devices electronically connected to the network;
(c) generate standardized insurance data requests based upon the insurance-related requests;
(d) transmit the standardized insurance data requests to insurance carrier servers;
(e) receive standardized insurance data responses from the insurance carrier servers; and
(f) store data associated with the requests and responses for tracking insurance transactions.

23. A data storage device for a plurality of different insurance agencies, said data storage device comprising: a memory device storing a plurality of instructions which direct a server to:
(a) host a plurality of different agency websites which are accessible by a plurality of different Internet access devices;
(b) transmit HTML data to the Internet access devices;
(c) display a plurality of web pages on each of the agency websites;
(d) execute a plurality of different types of predetermined database requests;
(e) execute a plurality of different types of predetermined server requests; and
(f) track data associated with insurance transactions.

24. The data storage device of claim 23, wherein the database requests include at least one contact request.

25. The data storage device of claim 23, wherein the database requests include at least one account request.

26. The data storage device of claim 23, wherein the database requests include at least one invoice request.

27. The data storage device of claim 23, wherein the database requests include at least one payment request.

28. The data storage device of claim 23, wherein the database requests include at least one payment tracking request.

29. The data storage device of claim 23, wherein the database requests include at least one reporting request.

30. The data storage device of claim 23, wherein the database requests include at least one statement request.

31. The data storage device of claim 23, wherein the database requests include at least one searching request.

32. The data storage device of claim 23, wherein the database requests include at least one messaging request.

33. The data storage device of claim 23, wherein the database requests include at least one accounting system interfacing request.

34. The data storage device of claim 23, wherein the database requests include at least one customization request.

35. The data storage device of claim 23, wherein the server requests include at least one request for an insurance policy quote.

36. The data storage device of claim 23, wherein the server requests include at least one request for an insurance policy binder.

37. The data storage device of claim 23, wherein the server requests include at least one request for an insurance policy.

38. The data storage device of claim 23, wherein the server requests include at least one request for a response to an insurance policy claim.

39. The data storage device of claim 23, wherein the server requests include at least one request for an invoice.

40. The data storage device of claim 23, wherein the server requests include at least one request for payment.

41. The data storage device of claim 23, which includes instructions directing the server to provide an electronic notice to an agent or carrier when a predetermined type of event occurs.

42. The data storage device of claim 41, wherein the predetermined type of event includes a weather event.

43. The data storage device of claim 41, wherein the predetermined type of event includes an automobile accident.

44. The data storage device of claim 41, wherein the predetermined type of event includes damage to property.

45. The data storage device of claim 41, wherein the predetermined type of event includes an illness to a person.

46. The data storage device of claim 41, wherein the predetermined type of event includes injury to a person.

47. The data storage device of claim 23, which includes instructions directing the server to enable a plurality of people to communicate with one another in real-time on websites hosted by the server.

48. The data storage device of claim 23, which includes instructions directing the server to enable a plurality of people to communicate with one another in real-time on websites hosted by a plurality of different servers.

49. A data storage device electronically connected to a first server, the first server connected, over a network, to at least one client computer and at least one insurance carrier server, said data storage device comprising: a memory device storing standardized insurance data generator code and standardized insurance data processor code.

50. The data storage device of claim 49, wherein the network is an Internet.

51. The data storage device of claim 49, wherein the standardized data generator code includes XML insurance file generator code.

52. The data storage device of claim 49, wherein the standardized data processor code includes XML insurance file parser code.

53. A data storage device electronically connected to a first server, the first server electronically connected to a database and the first server connected, over an Internet, to a plurality of client computers and a plurality of insurance carrier servers, said data storage device comprising: a memory device storing XML insurance file generator code; XML insurance file parser code; database request code; and server request code.

54. The data storage device of claim 53, wherein the memory device stores management code.

55. A data storage device electronically connected to a first server, the first server electronically connected to the Internet, said data storage device comprising: a memory device storing a plurality of instructions which Internet access devices can read, through the use of a predetermined web browser program, said instructions directing the server to:
(a) receive insurance data requests from the Internet access devices;
(b) generate insurance data in response to predetermined insurance data requests;
(c) store insurance data;
(d) retrieve insurance data;
(e) manipulate insurance data;
(f) graphically represent insurance data; and
(g) track insurance data associated with insurance transactions.

56. A data storage device for use by different insurance agencies, said data storage device electronically connected to an application server, the application server electronically connected to an Internet, said data storage device comprising:
a memory device storing a plurality of instructions which agency computers of different insurance agencies can use to transmit insurance data requests to the application server and to receive insurance data responses from the application server, said agency computers including a web browser program, said application server connected to at least one insurance carrier server over the Internet.

57. The data storage device of claim 56, wherein the insurance data requests include insurance transaction requests.

58. The data storage device of claim 56, wherein the insurance data requests include insurance policy quote requests.

59. The data storage device of claim 56, wherein the insurance data requests include insurance policy purchase requests.

60. The data storage device of claim 56, wherein the insurance data responses include insurance policy transaction responses.

61. The data storage device of claim 56, wherein the insurance data responses include insurance policy quote responses.

62. The data storage device of claim 56, wherein the insurance data responses include insurance policy sale responses.

63. A data storage device electronically connected to a first server, the first server connected to a client computer over an Internet client/server communication channel, the first server connected to a second server over an Internet peer-to-peer communication channel, said data storage device comprising: a memory device storing a plurality of instructions directing the first server to:
(a) host at least one agent website which is accessible by at least one client computer;
(b) receive an insurance data request from the client computer;
(c) generate XML request files from the insurance data request;
(d) transmit the XML request files to a second server;
(e) receive XML response files from the second server;
(f) transmit the XML response files to the client computer;
(a) transmit predetermined HTML files to the client computer;
(g) execute at least one database request;
(h) track data associated with insurance transactions;
(i) store insurance data for insurance agents;
(j) organize insurance data for insurance agents; and
(k) retrieve insurance data in response to requests made through the agent website.

64. A system for facilitating insurance industry activities comprising:
a client/server communication channel for connecting a client computer to a first server over an Internet;
a peer-to-peer communication channel for connecting the first server to a second server over the Internet; and
a data storage device storing a plurality of instructions directing the first server to:
(a) host at least one agent website which is accessible by the client computer;
(b) transmit HTML insurance files to the agent website;
(c) receive a non-XML insurance data request from the client computer;
(d) generate an XML insurance file request based upon the non-XML insurance data request;
(e) transmit the XML insurance file request to an insurance carrier server;
(f) receive an XML insurance file response from the insurance carrier server;
(g) transmit the XML insurance file response to the client computer;
(h) execute at least one database request; and
(i) track insurance data associated with insurance transactions.

65. A network architecture for conducting insurance industry activities, the network architecture comprising:
a client/server communication channel for connecting a client computer to a first server over a network;
a peer-to-peer communication channel for connecting the first server to a second server over the network;
a data storage device electronically connected to the first server; and
code for generating standardized insurance data from the insurance data received from the second server or the client computer, said code stored on the data storage device.

66. The network architecture of claim 65, wherein the network is an Internet.

67. The network architecture of claim 65, wherein the second server is an insurance carrier server.

68. The network architecture of claim 65, wherein the code is used by the first server to transmit standardized insurance data between the client computer and the second server.

69. The network architecture of claim 65, wherein the code includes XML file generator code.

70. The network architecture of claim 65, wherein at least part of the standardized insurance data includes XML standardized insurance data.

71. The network architecture of claim 65, which includes at least one computer program stored within the data storage device which the first server uses to provide an insurance agent with assistance in operating the insurance agent's insurance business.

72. The network architecture of claim 65, which includes at least one computer program stored within the data storage device which instructs the first server to transmit predetermined insurance data requests to the second server.

73. The network architecture of claim 65, which includes a plurality of client computers which are accessible by a plurality of insurance agents and insurance customers.

74. The network architecture of claim 73, which includes at least one computer program stored within the data storage device which instructs the first server to transmit predetermined insurance data responses to the client computers for receipt by predetermined insurance agents or insurance customers.

75. A network architecture used for conducting insurance industry activities, the network architecture comprising:
a client/server communication channel for connecting a client computer to a first server over a network;
a peer-to-peer communication channel for connecting the first server to a plurality of insurance carrier servers over the network;
a data storage device electronically connected to the first server; and
at least one computer program stored within the data storage device which instructs the first server to transmit standardized insurance data between the client computer and the insurance carrier servers.

76. The network architecture of claim 75, wherein the standardized insurance data includes XML standardized insurance data.

77. A network architecture for conducting insurance industry activities, the network architecture comprising:
a client/server communication channel for connecting a plurality of client computers to a first server over a network;
a peer-to-peer communication channel for connecting the first server to a plurality of insurance carrier servers;
a data storage device electronically connected to the first server;
at least one computer program stored within the data storage device which instructs the first server to generate standardized insurance data and to transmit the standardized insurance data between the client computers and the insurance carrier servers for the performance of insurance transactions.

78. The network architecture of claim 77, wherein the standardized insurance data includes XML standardized insurance data.

79. The network architecture of claim 77, wherein the transactions include selling at least one insurance policy.

80. The network architecture of claim 77, wherein the transactions include purchasing at least one insurance policy.

81. The network architecture of claim 77, wherein the transactions include contacting customers.

82. The network architecture of claim 77, wherein the transactions include distributing marketing information.

83. The network architecture of claim 77, wherein the transactions include submitting policy applications to insurance carriers.

84. The network architecture of claim 77, wherein the transactions include receiving policy quotes from insurance carriers.

85. The network architecture of claim 77, wherein the transactions include binding of insurance policies.

86. The network architecture of claim 77, wherein the transactions include issuance of insurance policies from insurance carriers.

87. The network architecture of claim 77, wherein the transactions include tracking of insurance policies.

88. The network architecture of claim 77, wherein the transactions include submission of insurance claims to insurance carriers.

89. The network architecture of claim 77, wherein the transactions include invoicing.

90. A network architecture used for conducting insurance transactions, the network architecture comprising:
at least one electronic device electronically connected to a wide-area network;
a first server electronically connected to the wide-area network;
at least one data storage device electronically connected to the first server;
standardized data generator code stored within the data storage device; and
a plurality of insurance carrier servers electronically connected to the first server through the wide-area network.

91. The network architecture of claim 90, wherein the electronic device is a computer.

92. The network architecture of claim 90, wherein the electronic device is portable.

93. The network architecture of claim 90, wherein the wide-area network is an Internet.

94. The network architecture of claim 90, wherein the standardized data generator code includes XML file generator code.

95. The network architecture of claim 90, wherein the insurance transactions include selling at least one insurance policy.

96. The network architecture of claim 90, wherein the insurance transactions include purchasing at least one insurance policy.

97. The network architecture of claim 90, which includes standardized data processing code stored within the data storage device.

98. A network architecture used for conducting insurance transactions, the network architecture comprising:
at least one electronic device electronically connected to an Internet;
a browser program stored in a first storage device which is electronically connected to the electronic device;
a first server electronically connected to the Internet;
a second storage device electronically connected to the first server;
standardized data generator code and standardized data processor code stored within the second storage device;
a first database electronically connected to the first server;
raw data associated with insurance transactions stored within the first database;
a plurality of insurance carrier servers electronically connected to the first server through the Internet;
an insurance carrier database electronically connected to each of the insurance carrier servers; and
insurance carrier data stored within the insurance carrier databases.

99. The network architecture of claim 98, wherein the standardized data generator code includes XML file generator code.

100. The network architecture of claim 98, wherein the standardized data processor code includes XML file parser code.

101. The network architecture of claim 98, wherein the insurance transactions include selling at least one insurance policy.

102. The network architecture of claim 98, wherein the insurance transactions include purchasing at least one insurance policy.

103. The network architecture of claim 98, wherein the electronic device is a computer.

104. The network architecture of claim 98, wherein the electronic device is portable.

105. The network architecture of claim 98, wherein the electronic device includes a wireless connection to the Internet.

106. The network architecture of claim 98, which includes management code stored within the second storage device.

107. The network architecture of claim 98, which includes server request code stored within the second storage device.

108. The network architecture of claim 98, which includes database request code stored within the second storage device.

109. A network architecture used for conducting insurance industry activities, the network architecture comprising:
a plurality of browsers electronically connected to a World Wide Web portion of an Internet;
a first server electronically connected to the Internet;
at least one agent website hosted by the first server;
a first database electronically connected to the first server;
insurance-related data stored within the first database;
a first storage device electronically connected to the first server;
HTML files stored within the first storage device;
XML file generator code and XML file parser code stored within the first storage device;
a plurality of carrier servers of different insurance carriers electronically connected to the first server through the Internet;
at least one insurance carrier database electronically connected to each of the carrier servers;
insurance carrier data stored within each of the insurance carrier databases;
at least one resource provider server electronically connected to the first server through the Internet;
at least one resource database electronically connected to the resource provider server; and
insurance resource data stored within the resource databases.

110. The network architecture of claim 109, wherein the insurance industry activities include selling at least one insurance policy.

111. The network architecture of claim 109, wherein the insurance industry activities include purchasing at least one insurance policy.

112. The network architecture of claim 109, which includes server request code stored within the first storage device.

113. The network architecture of claim 109, which includes agency management code stored within the first storage device.
